(19) United States
(12) Patent Application Publication
(10) Pub. No.: US 2025/0091960 A1
(43) Pub. Date: Mar. 20, 2025

(54) FUNCTIONALLY GRADED SiAlON COMPOSITECUTTING TOOL

(71) Applicant: KING FAHD UNIVERSITY OF PETROLEUM AND MINERALS, Dhahran (SA)

(72) Inventors: Syed Sohail AKHTAR, Dhahran (SA); Amer Duraywish ALOTAIBI, Dhahran (SA); Abba Abdulhamid ABUBAKAR, Dhahran (SA); Abbas Saeed HAKEEM, Dhahran (SA); Khaled S. AL-ATHEL, Dhahran (SA); Akeem Yusuf ADESINA, Dhahran (SA)

(73) Assignee: KING FAHD UNIVERSITY OF PETROLEUM AND MINERALS, Dhahran (SA)

(21) Appl. No.: 18/467,936

(22) Filed: Sep. 15, 2023

(51) Int. Cl. C04B 35/597; C04B 35/64

(52) U.S. Cl. CPC C04B 35/597; C04B 35/64; C04B 2235/3217; C04B 2235/3856; C04B 2235/386; C04B 2235/3869; C04B 2235/3873; C04B 2235/405; C04B 2235/5436; C04B 2235/5445; C04B 2235/5454; C04B 2235/75; C04B 2235/77; C04B 2235/9607

(57) ABSTRACT

A functionally graded (FG) SiAlON composite cutting tool includes a cutting head having a cutting surface containing the FG SiAlON composite. The FG SiAlON composite is obtained by sintering one or more powder compositions containing SiO₂ particles having a particle size of 20 to 50 nanometers (nm), AlN particles having a particle size of up to 100 nm, Si₃N₄ particles having a particle size of 300 to 500 nm, Al₂O₃ particles having a particle size of up to 100 nm, Yb₂O₃ particles having a particle size of up to 100 nm, and one or more reinforcement additives selected from the group consisting of cobalt (Co) particles, titanium carbonitride (TiCN) particles, cobalt alloy particles, and a boron nitride compound. The one or more reinforcement additives have an average particle size in a range of 50 nm to 35 micrometers (μm).

### STATEMENT REGARDING PRIOR DISCLOSURE BY THE INVENTORS

Aspects of this technology are described in “Development and analysis of functionally-graded SiAlON composites with computationally designed properties for cutting inserts” published in Journal of Materials Research and Technology, Volume 23, 5861-5879, which is incorporated herein by reference in its entirety.

### STATEMENT OF ACKNOWLEDGEMENT

This research was supported by the Interdisciplinary Research Center for Intelligent Manufacturing and Robotics at King Fahd University of Petroleum and Minerals under the project INMR2102.

### BACKGROUND

### Technical Field

The present disclosure is directed to a cutting tool, particularly to a functionally graded (FG) SiAlON composite cutting tool.

### DESCRIPTION OF THE RELATED PRIOR ART

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Rapid industrial advancements and consumption of industrial goods have led to an increase in the need to create innovative cutting tools. There is especially an increase in demand for developing the new cutting tools with exceptional thermomechanical and tribological characteristics, in order to effectively address the expanding demands within the machining industry.

Recent years have seen the emergence of functionally graded materials (FGMs) as a viable option for crafting these new tools. FGMs are composites that possess non-uniform variation of composition and structure across the volume of the materials. This attribute of FGMs eliminates many problems commonly encountered with traditional composites, such as poor mechanical integrity, and transport losses due to low interfacial adhesion. Moreover, FGMs provide a resolution to the issue of thermal expansion mismatch that frequently troubles conventional high-temperature composites. The benefits of making a cutting tool by utilizing functionally graded (FG) composites include improvements in thermal diffusivity, fracture toughness, and tribological properties.

An intriguing application of the FGM concept involves ceramic materials, particularly in the context of cutting tools. Owing to desirable mechanical and tribological properties for high-temperature cutting operations, ceramic inserts are widely employed to cut hard and difficult-to-machine materials. However, the cutting performance of the ceramic tools and inserts is significantly impacted by their low thermal and electrical conductivity, thermal shock resistance, brittleness, and low fracture toughness. Among the various ceramic classes, SiAlON exhibits potential as a cutting tool insert material for high-temperature applications. This is attributed to its exceptional mechanical, chemical, and tribological characteristics. Among the SiAlON family, the β-phase and α-phase polymorphs are commonly used to craft cutting tool inserts. The β-SiAlON possesses elongated grains and high fracture toughness but has a lower hardness, wear resistance, and temperature resistance. On the other hand, the α-SiAlON demonstrates suitability for engineering applications due to its elevated hardness and outstanding resistance to wear, oxidation, and elevated temperatures. However, its toughness and machinability are relatively low, thereby impacting its efficacy as a viable cutting tool material.

Although SiAlON ceramic composites have been studied, the development of functionally-graded SiAlON composites has remained unresolved. This lack of progress has limited the application of SiAlON-based composite components across diverse industrial sectors. Thus, there is still a need for innovative approaches to manufacture functionally-graded SiAlON composites. More importantly, the challenge is that such methods should be simple, cost-effective, and rapid to attract industries to adopt these processes.

In view of the foregoing, one objective of the present disclosure is to provide a functionally graded (FG) SiAlON composite cutting tool encompassing a range of attributes, including reinforcing volume fractions, particle sizes, layer numbers, layer material compositions, interfacial resistance, and porosity. A second objective of the present disclosure is to provide a method of making the FG SiAlON composite cutting tool.

### SUMMARY

In an exemplary embodiment, a functionally graded (FG) SiAlON composite cutting tool is disclosed. The cutting tool includes a cutting head having a cutting surface. In some embodiments, the cutting surface includes the FG SiAlON composite. In some embodiments, the FG SiAlON composite is obtained by sintering one or more powder compositions, and wherein the one or more powder compositions contain SiO₂ particles having a particle size of 20 to 50 nanometers (nm), AlN particles having a particle size of up to 100 nm, Si3N4 particles having a particle size of 300 to 500 nm, Al₂O₃ particles having a particle size of up to 100 nm, Yb₂O₃ particles having a particle size of up to 100 nm, and one or more reinforcement additives selected from the group consisting of cobalt (Co) particles, titanium carbonitride (TiCN) particles, cobalt alloy particles, and a boron nitride compound. In some embodiments, the one or more reinforcement additives have an average particle size in a range of 50 nm to 35 micrometers (μm). In some embodiments, the cutting surface of the FG SiAlON composite cutting tool shows improved thermomechanical and tribological properties compared to a cutting surface of a SiAlON composite cutting tool in the absence of the one or more reinforcement additives.

In some embodiments, the one or more reinforcement additives of the one or more powder compositions contain the Co particles, the TiCN particles and the cobalt alloy particles. In some embodiments, the Co has an average particle size of about 2 μm. In some embodiments, the TiCN has an average particle size of about 1.45 μm. In some embodiments, the cobalt alloy has an average particle size of about 32 μm.

In another embodiment, the one or more reinforcement additives of the one or more powder compositions contain the cobalt alloy particles of a cobalt-chromium alloy (Co212-C). In some embodiments, the Co212-C contains about 0.5 to 1 wt. % Fe, about 0.1 to 0.6 wt. % C, about 27 to 30 wt. % Cr, about 1 wt. % or less Ni, about 5 to 7 wt. % Mo, about 1 wt. % or less Si, about 1 wt. % or less Mn, and a Co balance, each wt. % based on a total weight of the Co212-C.

In some embodiments, the one or more reinforcement additives of the one or more powder compositions comprise at least one boron nitride compound selected from the group consisting of a hexagonal boron nitride (h-BN), a modified h-BN, a rhombohedral boron nitride, a modified rhombohedral boron nitride, a turbostratic boron nitride, and a modified turbostratic boron nitride.

In another exemplary embodiment, the boron nitride compound is h-BN containing platelet-shaped particles. In some embodiments, the platelet-shaped particles have a thickness of 50 to 100 nm, a length of 1 to 5 μm, and an aspect ratio of 10 to 100.

In some embodiments, the FG SiAlON composite of the cutting surface includes 5 layers of 3 symmetrical compositions having a total thickness (T). In some embodiments, the 5 layers of the FG SiAlON composite contains a bottom layer above and adjacent to the cutting surface of the cutting head; a first inner layer above and adjacent to the bottom layer; a core layer above and adjacent to the first inner layer; a second inner layer above and adjacent to the core layer; and a top layer above and adjacent to the second inner layer. In some embodiments, the bottom layer and the top layer have the same first composition and are obtained from a first powder composition and have a first thickness (t₁). In some embodiments, the first inner layer and the second inner layer have the same second composition and are obtained from a second powder composition and have a second thickness (t₂). In some embodiments, the core layer have a third composition and is obtained from a third powder composition and have a core thickness (t_{c}). In some embodiments, 2×t₁+2×t₂+t_{c}=T.

In some embodiments, a first ratio of t₁ to T of the FG SiAlON composite is about 1:20 to 1:10. In some embodiments, a second ratio of t₂ to T of the FG SiAlON is about 1:10 to 1:5. In some embodiments, a third ratio of t_{c} to T of the FG SiAlON is about 2:5 to 2:3.

In some embodiments, t₁ is about 0.655 millimeters (mm). In some embodiments, t₂ is about 1.35 mm. In some embodiments, t_{c} is about 4 mm.

In some embodiments, the first composition of the bottom layer and the top layer of the FG SiAlON composite and the first powder composition are substantially the same. In some embodiments, the first powder composition contains 0.25 to 0.4 wt. % SiO₂; 10 to 14 wt. % AlN; 60 to 70 wt. % Si₃N₄; 0.3 to 0.45 wt. % Al₂O₃; 10 to 14 wt. % Yb₂O₃; 2 to 4 wt. % h-BN; optionally 8 to 10 wt. % TiCN; optionally 2 to 3 wt. % Co; and optionally 2 to 3 wt. % Co212-C, each wt. % based on a total weight of the first powder composition.

In some embodiments, the second composition of the first inner layer and the second inner layer of the FG SiAlON composite and the second powder composition are substantially the same. In some embodiments, the second powder composition contains 0.25 to 0.4 wt. % SiO₂; 8 to 14 wt. % AlN; 55 to 70 wt. % Si₃N₄; 0.3 to 0.45 wt. % Al₂O₃; 8 to 14 wt. % Yb₂O₃; 1 to 3 wt. % h-BN; optionally 15 to 20 wt. % TiCN; optionally 4 to 6 wt. % Co; and optionally 4 to 6 wt. % Co212-C, each wt. % based on a total weight of the second powder composition.

In some embodiments, the third composition of the core layer of the FG SiAlON composite and the third powder composition are substantially the same. In some embodiments, the third powder composition contains 0.2 to 0.4 wt. % SiO₂; 6 to 15 wt. % AlN; 45 to 75 wt. % Si₃N₄; 0.2 to 0.45 wt. % Al₂O₃; 6 to 15 wt. % Yb₂O₃; optionally 25 to 40 wt. % TiCN; optionally 8 to 12 wt. % Co; and optionally 8 to 12 wt. % Co212-C, each wt. % based on a total weight of the third powder composition.

In some embodiments, the bottom layer and the top layer of the FG SiAlON composite contains about 0.31 wt. % SiO₂, about 11.62 wt. % AlN, about 63.74 wt. % Si₃N₄, about 0.35 wt. % Al₂O₃, about 11.80 wt. % Yb₂O₃, about 9.18 wt. % TiCN, about 3.01 wt. % h-BN, each wt. % based on a total weight of the first composition. In some embodiments, the first inner layer and the second inner layer of the FG SiAlON composite contains about 0.28 wt. % SiO₂, about 10.68 wt. % AlN, about 58.65 wt. % Si₃N₄, about 0.32 wt. % Al₂O₃, about 10.85 wt. % Yb₂O₃, about 17.48 wt. % TiCN, about 1.72 wt. % h-BN, each wt. % based on a total weight of the second composition. In some embodiments, the core layer of the FG SiAlON composite contains about 0.24 wt. % SiO₂, about 8.99 wt. % AlN, about 49.36 wt. % Si₃N₄, about 0.27 wt. % Al₂O₃, about 9.13 wt. % Yb₂O₃, about 32.00 wt. % TiCN, each wt. % based on a total weight of the third composition.

In some embodiments, the FG SiAlON composite has a density of about 3.725 g/cm³. In some embodiments, the FG SiAlON composite has a thermal conductivity of 4.8 to 6.3 W/mK. In some embodiments, the FG SiAlON composite has a thermal expansion coefficient of 3.1 to 3.5 μ/° C.

In some embodiments, the bottom layer and the top layer of the FG SiAlON composite contains about 0.33 wt. % SiO₂, about 12.47 wt. % AlN, about 68.43 wt. % Si₃N₄, about 0.37 wt. % Al₂O₃, about 12.66 wt. % Yb₂O₃, about 2.62 wt. % Co, about 3.10 wt. % h-BN, each wt. % based on a total weight of the first composition. In some embodiments, the first inner layer and the second inner layer of the FG SiAlON composite contains about 0.33 wt. % SiO₂, about 12.31 wt. % AlN, about 67.55 wt. % Si₃N₄, about 0.36 wt. % Al₂O₃, about 12.50 wt. % Yb₂O₃, about 5.13 wt. % Co, about 1.81 wt. % h-BN, each wt. % based on a total weight of the second composition. In some embodiments, the core layer of the FG SiAlON composite contains about 0.32 wt. % SiO₂, about 11.93 wt. % AlN, about 65.45 wt. % Si₃N₄, about 0.36 wt. % Al₂O₃, about 12.11 wt. % Yb₂O₃, about 9.84 wt. % Co, each wt. % based on a total weight of the third composition.

In some embodiments, the FG SiAlON composite has a density of about 3.575 g/cm³. In some embodiments, the FG SiAlON composite has a thermal conductivity of 4.4 to 4.8 W/mK. In some embodiments, the FG SiAlON composite has a thermal expansion coefficient of 2.6 to 3.0 μ/° C.

In some other embodiments, the bottom layer and the top layer of the FG SiAlON composite contains about 0.33 wt. % SiO₂, about 12.49 wt. % AlN, about 68.54 wt. % Si₃N₄, about 0.37 wt. % Al₂O₃, about 12.68 wt. % Yb₂O₃, about 2.48 wt. % Co212-C, about 3.10 wt. % h-BN, each wt. % based on a total weight of the first composition. In some other embodiments, the first inner layer and the second inner layer of the FG SiAlON composite contains about 0.33 wt. % SiO₂, about 12.34 wt. % AlN, about 67.74 wt. % Si₃N₄, about 0.37 wt. % Al₂O₃, about 12.53 wt. % Yb₂O₃, about 4.86 wt. % Co212-C, about 1.82 wt. % h-BN, each wt. % based on a total weight of the second composition. In some other embodiments, the core layer of the FG SiAlON composite contains about 0.32 wt. % SiO₂, about 11.99 wt. % AlN, about 65.81 wt. % Si₃N₄, about 0.36 wt. % Al₂O₃, about 12.18 wt. % Yb₂O₃, about 9.33 wt. % Co212-C, each wt. % based on a total weight of the third composition.

In some examples, the FG SiAlON composite has a density of about 3.566 g/cm³. In some examples, the FG SiAlON composite has a thermal conductivity of 3.8 to 4.4 W/mK. In some examples, the FG SiAlON composite has a thermal expansion coefficient of 2.7 to 3.1 μ/° C.

Aspects of the present disclosure are also related to a method of making the FG SiAlON composite cutting tool. The method includes preparing the FG SiAlON composite by mixing nanoparticles of SiO₂, AlN, Si₃N₄, Al₂O₃, and Yb₂O₃, and one or more reinforcement additives selected from the group consisting of cobalt (Co) particles, titanium carbonitride (TiCN) particles, cobalt alloy particles, and a boron nitride compound in a solvent and sonicating to form a first mixture; drying the first mixture to form a first powder composition; mixing the nanoparticles of SiO₂, AlN, Si₃N₄, Al₂O₃, and Yb₂O₃, and the one or more reinforcement additives selected from the group consisting of cobalt (Co) particles, titanium carbonitride (TiCN) particles, cobalt alloy particles, and a boron nitride compound in the solvent and sonicating to form a second mixture; drying the second mixture to form a second powder composition; mixing the nanoparticles of SiO₂, AlN, Si₃N₄, Al₂O₃, and Yb₂O₃, and the one or more reinforcement additives selected from the group consisting of cobalt (Co) particles, titanium carbonitride (TiCN) particles, and cobalt alloy particles in the solvent and sonicating to form a third mixture; drying the third mixture to form a third powder composition; forming a sample by introducing a first portion of the first powder composition on to the cutting surface of the cutting head thereby forming a bottom powder layer disposed on the cutting surface, introducing a first portion of the second powder composition onto a surface of the bottom powder layer thereby forming a first inner powder layer, introducing the third powder composition onto a surface of the first inner powder layer thereby forming a core powder layer, introducing a second portion of the second powder composition onto a surface of the core powder layer thereby forming a second inner powder layer, and introducing a second portion of the first powder composition onto a surface of the second inner powder layer thereby forming a top powder layer; and sintering by pressing and heating the sample via the top powder layer to form the FG SiAlON composite on the cutting surface of the cutting head. In some embodiments, the FG SiAlON composite comprises 5 layers of 3 symmetrical compositions and have a total thickness (T). In some examples, the FG SiAlON composite comprises a bottom layer above and adjacent to the cutting surface of the cutting head, a first inner layer above and adjacent to the bottom layer, a core layer above and adjacent to the first inner layer, a second inner layer above and adjacent to the core layer, and a top layer above and adjacent to the second inner layer. In some examples, the bottom layer and the top layer have the same first thickness (t₁). In some examples, the first inner layer and the second inner layer have the same second thickness (t₂). In some examples, the core layer has a third powder composition and a core thickness (t_{c}). In some examples, 2×t₁+2×t₂+t_{c}=T. In some examples, a first ratio of t₁ to T is about 0.08. In some examples, a second ratio of t₂ to T is about 0.17. In some examples, a third ratio of t_{c} to T is about 0.5.

In some embodiments, the solvent of at least one alcohol selected from the group consisting of methanol, ethanol, and propanol.

In some embodiments, the pressing is performed under a uniaxial pressure in a range of 30 to 70 megaPascals (MPa). In some examples, the heating is performed at a temperature in a range of 1400 to 1600° C.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of making a functionally graded (FG) SiAlON composite cutting tool; according to certain embodiments;

FIG. 2 illustrates a schematic figure of the FG SiAlON composite used to compute effective properties, according to certain embodiments;

FIG. 3 illustrates a spark plasma sintering process (SPS) schematic figure indicating powder layering inside of a graphite die and thickness of each layer, according to certain embodiments;

FIG. 4A shows variation of effective thermal conductivity with volume fractions of TiCN, according to certain embodiments;

FIG. 4B shows variation of effective thermal conductivity with volume fractions of Co, according to certain embodiments;

FIG. 4C shows variation of effective thermal conductivity with particle sizes for the Yb₂O₃-doped SiAlON composite having a 2% porosity, according to certain embodiments;

FIG. 4D shows variation of effective thermal conductivity with particle sizes for the Yb₂O₃-doped SiAlON composite having a 1% porosity, according to certain embodiments;

FIG. 5A shows variation of effective structural properties of Yb₂O₃-doped SiAlON composite with volume fractions and particle sizes with respect to thermal expansion coefficient for TiCN, according to certain embodiments;

FIG. 5B shows variation of effective structural properties of Yb₂O₃-doped SiAlON composite with volume fractions and particle sizes with respect to the thermal expansion co-efficient for Co, according to certain embodiments;

FIG. 5C shows a variation of effective structural properties of Yb₂O₃-doped SiAlON composite with volume fractions and particle sizes with respect to elastic modulus for TiCN, according to certain embodiments;

FIG. 5D shows a variation of effective structural properties of Yb₂O₃-doped SiAlON composite with volume fractions and particle sizes with respect to the elastic modulus for Co, according to certain embodiments;

FIG. 6A shows the temperature distribution developed across the thickness of a layered FG structure, according to certain embodiments;

FIG. 6B shows the temperature distribution gradient developed across the thickness of the layered FG structure, according to certain embodiments;

FIG. 6C shows the radial (residual) stress developed in a layered FG Yb₂O₃-doped SiAlON/TiCN/h-BN composite, according to certain embodiments;

FIG. 6D shows the strain energy density distribution developed in the layered FG Yb₂O₃-doped SiAlON/TiCN/h-BN composite, according to certain embodiments;

FIG. 7A shows a Field-Emission Scanning Electron Microscopy (FE-SEM) image of the FG Yb₂O₃-doped SiAlON composite samples showing fractured samples surface with α and β-SiAlON phases, according to certain embodiments;

FIG. 7B shows an FE-SEM image of the FG Yb₂O₃-doped SiAlON composite samples showing fractured samples surface with α and β-SiAlON phases with the composite interface between the top and the second layer of A3, according to certain embodiments;

FIG. 7C shows the FE-SEM images of the FG Yb₂O₃-doped SiAlON composite samples showing microstructure of FG SiAlON/TiCN/h-BN, according to certain embodiments;

FIG. 7D shows an FE-SEM image of the FG Yb₂O₃-doped SiAlON composite samples showing microstructure of FG SiAlON/TiCN/h-BN, according to certain embodiments;

FIG. 8 shows X-ray diffraction profiles of A1 (pure Yb₂O₃-doped SiAlON), A2 (Yb₂O₃-doped SiAlON with 4 vol % of 2 μm Co), A3 (FG TiCN and hBN in a Yb₂O₃-doped SiAlON matrix), A4 (FG 2 μm Cobalt and hBN in a Yb₂O₃-doped SiAlON matrix), A5 (FG 32 μm Cobalt and hBN in a Yb₂O₃-doped SiAlON matrix), A6 (Yb₂O₃-doped SiAlON with 20 vol % of TiCN), A7 (Yb₂O₃-doped SiAlON with 4 vol % of 32 μm Co), according to certain embodiments;

FIG. 9 shows an Energy-dispersive X-ray spectroscopy (EDX) of the outer layer of A3 indicating the weight percentage of the constituents, according to certain embodiments.

FIG. 10A shows a comparison of the loading-unloading curves of the core layers and bulk samples of various synthesized samples as indicated, according to certain embodiments;

FIG. 10B shows hardness indentation in A2 containing 4 vol % of Co, according to certain embodiments; and

FIG. 10C shows an interface between the top and second layer of A3, according to certain embodiments.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in which some, but not all embodiments of the disclosure are shown.

Further, as used herein, the use of singular includes plural and the words ‘a’, ‘an’ includes ‘one’ and means ‘at least one’ unless otherwise stated in this application.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, the term “substantially” unless otherwise specified, refers to a great extent or degree, e.g. “substantially the same” in context would be used to describe one composition which is to great extent or degree similar to another composition. The term “substantially similar” or equivalents thereof is meant that the composition, process, method, solution, media, supplement, excipient and the like, is at least 50%, 55%, 60%, 65%, 70%, 75%, 80%, at least 85%, at least 90%, at least 95%, or at least 99% similar to that previously described in the specification herein, or in a previously described process or method incorporated herein in its entirety.

The terms “elements” and “components” include a single unit as well as more than a single unit unless specified otherwise.

The terms “compound” and “derivative” as used herein, are used interchangeably, and refer to a chemical entity, whether in the solid, liquid, or gaseous phase, and whether in a crude mixture or purified and isolated.

The term “compounds” as used herein, refers to include the compounds disclosed in the present invention disclosure, salts, solvates, and salts of solvates, and mixtures, known and unknown variations and forms thereof.

The term “functionally graded” material or “FG” material is a composite that possesses non-uniform variation of composition and structure across the volume of the material. Depending on the design and functional requirements, the composition or structure can vary continuously or layer-wise.

In one aspect of the present invention disclosure, a functionally graded (FG) SiAlON composite cutting tool is disclosed. The cutting tool includes a cutting head having a cutting surface. The cutting surface includes the FG SiAlON composite. In some embodiments, at least 10%, at least 30%, at least 50%, at least 70%, at least 90%, or at least 99% of a total surface area of the cutting surface is covered by the FG SiAlON composite. Other ranges are also possible. In some further embodiments, the FG SiAlON composite is obtained by sintering one or more powder compositions containing nanoparticles of SiO₂, AlN, Si₃N₄, Al₂O₃, and Yb₂O₃.

In some embodiments, the SiO₂ nanoparticles of the one or more powder compositions have a particle size of 10 to 100 nanometers (nm), preferably 15 to 80 nm, or even more preferably 20 to 50 nm. In some embodiments, the AlN nanoparticles of the one or more powder compositions have a particle size of up to 200 nm, preferably up to 150 nm, or even more preferably up to 100 nm. In some embodiments, the Si₃N₄ nanoparticles of the one or more powder compositions have a particle size of 100 to 800 nm, preferably 200 to 600 nm, or even more preferably 300 to 500 nm. In some embodiments, the Al₂O₃ nanoparticles of the one or more powder compositions have a particle size of up to 200 nm, preferably up to 150 nm, or even more preferably up to 100 nm. In some embodiments, the Yb₂O₃ nanoparticles of the one or more powder compositions have a particle size of up to 200 nm, preferably up to 150 nm, or even more preferably up to 100 nm. Other ranges are also possible.

In some embodiments, the SiO₂ nanoparticles of the one or more powder compositions have a particle size of about 20, 25, 30, 35, 40, 45 nm. In some embodiments, the AlN particles of the one or more powder compositions has a particle size of about 1, 2, 3, 4, 5, 6, 7, 8, 9, 10, 15, 20, 25, 30, 35, 40, 45, 50, 55, 60, 65, 70, 75, 80, 85, 90, 95 nm. In some embodiments, the Si₃N₄ nanoparticles of the one or more powder compositions have a particle size of about 300, 310, 320, 330, 340, 350, 260, 370, 380, 390, 400, 410, 420, 430, 440, 450, 460, 470, 480, 490, 495 nm. In some embodiments, the Al₂O₃ nanoparticles of the one or more powder compositions have a particle size of about 1, 2, 3, 4, 5, 6, 7, 8, 9, 10, 15, 20, 25, 30, 35, 40, 45, 50, 55, 60, 65, 70, 75, 80, 85, 90, 95 nm. In some embodiments, the Yb₂O₃ nanoparticles of the one or more powder compositions have a particle size of about 1, 2, 3, 4, 5, 6, 7, 8, 9, 10, 15, 20, 25, 30, 35, 40, 45, 50, 55, 60, 65, 70, 75, 80, 85, 90, 95 nm. In some embodiments, the SiO₂ nanoparticles of the one or more powder compositions have a particle size of 50 nm, the AlN nanoparticles of the one or more powder compositions have a particle size of 100 nm, the Si₃N₄ nanoparticles of the one or more powder compositions have a particle size of 500 nm, the Si₃N₄ nanoparticles have a particle size of 500 nm, and the Al₂O₃ nanoparticles of the one or more powder compositions have a particle size of 100 nm. Other ranges are also possible.

The FG SiAlON composite further includes one or more reinforcement additives selected from the group consisting of cobalt (Co) particles, titanium carbonitride (TiCN) particles, cobalt alloy particles, and a boron nitride compound. In some embodiments, the boron nitride compound is at least one selected from the group consisting of a hexagonal boron nitride (h-BN), a modified h-BN, a rhombohedral boron nitride, a modified rhombohedral boron nitride, a turbostratic boron nitride, and a modified turbostratic boron nitride. In some embodiments, the boron nitride compound is included in combination with one or more boron-based ceramic materials. In another exemplary embodiment, the boron nitride compound is h-BN comprising platelet-shaped particle.

In some embodiments, the platelet-shaped particles have a thickness of 20 to 200 nm, preferably 30 to 150 nm, or even more preferably 50 to 100 nm; a length of 0.5 to 15 micrometers (μm), preferably 1 to 10 μm, or even more preferably 1 to 5 μm; and an aspect ratio of 5 to 200, preferably 8 to 150, or even more preferably 10 to 100. Other ranges are also possible.

The one or more reinforcement additives containing particles have an average particle size in a range of 10 nm to 50 μm, preferably 20 nm to 45 μm, preferably 30 nm to 40 μm, or even more preferably 50 nm to 35 μm. In some embodiments, the Co particles has an average particle size of about 0.5, 1, 1.5 to 1.7 μm. In some embodiments, the TiCN particles has an average particle size of about 0.5, 1, 1.4 μm. In some embodiments, the cobalt alloy particles has an average particle size of about 5, 10, 15, 0, 25, 30 μm. In some embodiments, the cobalt alloy is a cobalt-chromium alloy (Co212-C). The Co212-C includes about 0.5, 0.6, 0.7, 0.8 to 0.9 wt. % Fe, about 0.1, 0.2, 0.3, 0.4 to 0.5 wt. % C, about 27, 28 to 29 wt. % Cr, about 0.1, 0.2, 0.3, 0.4, 0.5. 0.6, 0.7, 0.8, 0.9 wt. % or more Ni, about 5, 6 to 6.5 wt. % Mo, about 0.1, 0.2, 0.3, 0.4, 0.5, 0.6, 0.7, 0.8 to 0.9 wt. % or more Si, about 0.1, 0.2, 0.3, 0.4, 0.5, 0.6, 0.7, 0.8 to 0.9 wt. % or more Mn, and a Co balance, each wt. % based on the total weight of the Co212-C. In some embodiments, the Co particles have an average particle size of about 2 μm; the TiCN particles have an average particle size of about 1.45 μm; and the cobalt alloy particles have an average particle size of about 32 μm. In another embodiment, the cobalt alloy is a cobalt-chromium alloy (Co212-C). In some embodiments, the Co212-C contains about 0.5 to 1 wt. % Fe, about 0.1 to 0.6 wt. % C, about 27 to 30 wt. % Cr, about 1 wt. % or less Ni, about 5 to 7 wt. % Mo, about 1 wt. % or less Si, about 1 wt. % or less Mn, and a Co balance, each wt. % based on the total weight of the Co212-C. Other ranges are also possible.

In some embodiments, the FG SiAlON composite comprises one or more self-lubricating agents. In some embodiments, the one or more self-lubricating agents include graphite and/or graphite-like materials. In some embodiments, the self-lubricating agent is graphite having a particle size of 10 nm to 50 μm, preferably 20 nm to 45 μm, preferably 30 nm to 40 μm, or even more preferably 50 nm to 35 μm. In some embodiments, the graphite particles have a flake-like shape. Other ranges are also possible.

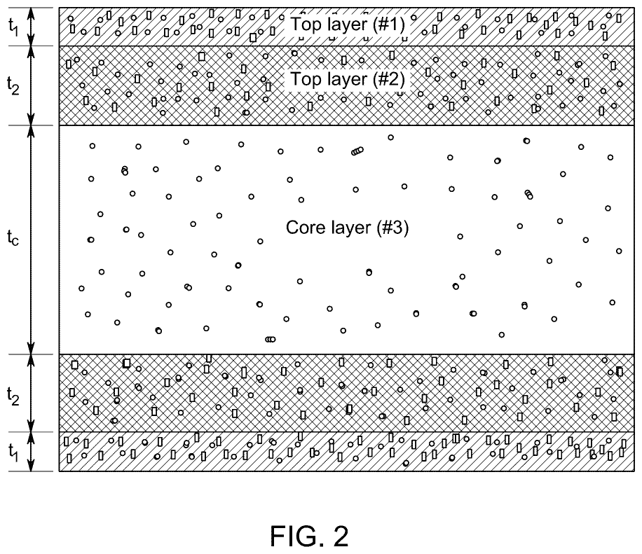

In some embodiments, the FG SiAlON composite on the cutting surface includes 1 to 10 layers of 1-5 symmetrical powder compositions. In some embodiments, the FG SiAlON composite on the cutting surface includes 5 layers of 3 symmetrical powder compositions having a total thickness (T). Referring to FIG. 2, the 5 layers of the FG SiAlON composite include a bottom layer above and adjacent to the cutting surface of the cutting head; a first inner layer above and adjacent to the bottom layer; a core layer above and adjacent to the first inner layer; a second inner layer above and adjacent to the core layer; and a top layer above and adjacent to the second inner layer. In some embodiments, the bottom layer and the top layer have the same first composition and are obtained from a first powder composition and have a first thickness (t₁). In some embodiments, the first inner layer and the second inner layer have the same second composition and are obtained from a second powder composition and have a second thickness (t₂). In some embodiments the core layer have a third composition and is obtained from a third powder composition and have a core thickness (t_{c}). In some embodiments, 2×t₁+2×t₂+t_{c}=T. In some embodiments, a first ratio of t₁ to T of the FG SiAlON composite is about 1:20, 1:19, 1:18, 1:17, 1:16, 1:15, 1:14, 1:13, 1:12 to 1:11; a second ratio of t₂ to T of the FG SiAlON is about 1:10, 1:9, 1:8, 1:7 to 1:6; and a third ratio of t_{c} to T of the FG SiAlON is about 2:5 to 2:4. In some embodiments, a first ratio of t₁ to T of the FG SiAlON composite is about 1:20 to 1:10; a second ratio of t₂ to T of the FG SiAlON is about 1:10 to 1:5; and a third ratio of t_{c} to T of the FG SiAlON is about 2:5 to 2:3. In some embodiments, t₁ is about 0.155, 0.255, 0.355, 0.455 to 0.555 millimeters (mm); t₂ is about 1, 1.15, 1.35 mm; and t_{c} is about 1, 2 to 3 mm. In some embodiments, t₁ is about 0.655 millimeters (mm); t₂ is about 1.35 mm; and t_{c} is about 4 mm. In some embodiments, the first composition of the bottom layer and the top layer of the FG SiAlON composite and the first powder composition are substantially the same. In some embodiments, the first powder composition includes 0.25, 0.3, 0.35 to 0.37 wt. % SiO₂; 10, 11, 12 to 13 wt. % AlN; 60, 65 to 67 wt. % Si₃N₄; 0.3 to 0.40 wt. % Al₂O₃; 10, 11, 12 to 13 wt. % Yb₂O₃; 2 to 3 wt. % h-BN; optionally 8 to 9 wt. % TiCN; optionally 2 to 2.5 wt. % Co; and optionally 2 to 2.7 wt. % Co212-C, each wt. % based on the total weight of the first powder composition. In some embodiments, the first powder composition includes 0.25 to 0.4 wt. % SiO₂; 10 to 14 wt. % AlN; 60 to 70 wt. % Si₃N₄; 0.3 to 0.45 wt. % Al₂O₃; 10 to 14 wt. % Yb₂O₃; 2 to 4 wt. % h-BN; optionally 8 to 10 wt. % TiCN; optionally 2 to 3 wt. % Co; and optionally 2 to 3 wt. % Co212-C, each wt. % based on the total weight of the first powder composition. Other ranges are also possible.

In some embodiments, the second composition of the first inner layer and the second inner layer of the FG SiAlON composite and the second powder composition are substantially the same. In some embodiments, the second powder composition includes 0.25 to 0.35 wt. % SiO₂; 8, 9, 10, 11, 3 12 to 1 wt. % AlN; 55, 56, 57, 58, 59, 60, 61, 62, 63, 64, 65, 67, 68 to 69 wt. % Si₃N₄; 0.3 to 0.40 wt. % Al₂O₃; 8, 9, 10, 11, 12 to 13 wt. % Yb₂O₃; 1 to 2.5 wt. % h-BN; optionally 15, 16, 17, 18 to 19 wt. % TiCN; optionally 4 to 5 wt. % Co; and optionally 4 to 5.5 wt. % Co212-C, each wt. % based on the total weight of the second powder composition. In some embodiments, the second powder composition includes 0.25 to 0.4 wt. % SiO₂; 8 to 14 wt. % AlN; 55 to 70 wt. % Si₃N₄; 0.3 to 0.45 wt. % Al₂O₃; 8 to 14 wt. % Yb₂O₃; 1 to 3 wt. % h-BN; optionally 15 to 20 wt. % TiCN; optionally 4 to 6 wt. % Co; and optionally 4 to 6 wt. % Co212-C, each wt. % based on the total weight of the second powder composition. Other ranges are also possible.

In some embodiments, the third composition of the core layer of the FG SiAlON composite and the third powder composition are substantially the same. In some embodiments, the third powder composition includes 0.2 to 0.35 wt. % SiO₂; 6, 7, 8, 9, 10, 11, 12, 13 to 14 wt. % AlN; 45, 55, 65 to 70 wt. % Si₃N₄; 0.2, 0.3 to 0.4 wt. % Al₂O₃; 6, 7, 8, 9, 11, 12, 13 to 14 wt. % Yb₂O₃; optionally 25, 26, 27, 28, 29, 30, 31, 32, 33, 34, 35, 36, 37, 38 to 39 wt. % TiCN; optionally 8, 9, 10 to 11 wt. % Co; and optionally 8, 9, 10 to 11 wt. % Co212-C, each wt. % based on the total weight of the third powder composition. In some embodiments, the third powder composition includes 0.2 to 0.4 wt. % SiO₂; 6 to 15 wt. % AlN; 45 to 75 wt. % Si₃N₄; 0.2 to 0.45 wt. % Al₂O₃; 6 to 15 wt. % Yb₂O₃; optionally 25 to 40 wt. % TiCN; optionally 8 to 12 wt. % Co; and optionally 8 to 12 wt. % Co212-C, each wt. % based on the total weight of the third powder composition. Other ranges are also possible.

In some embodiments, the bottom layer and the top layer of the FG SiAlON composite includes about 0.1, 0.2 to 0.30 wt. % SiO₂, about 1, 2, 3, 4, 5, 6, 7, 8, 9, 10 to 11 wt. % AlN, about 10, 20, 30, 40, 50 to 60 wt. % Si₃N₄, about 0.1, 0.2 to 0.30 wt. % Al₂O₃, about 1, 2, 3, 4, 5, 6, 7, 8, 9, 10 to 11 wt. % Yb₂O₃, about 9.18 wt. % TiCN, about 3.01 wt. % h-BN, each wt. % based on the total weight of the first composition. Further, the first inner layer and the second inner layer of the FG SiAlON composite includes about 0.1, 0. 2 to 0.25 wt. % SiO₂, about 1, 2, 3, 4, 5, 6, 7, 8, 9 to 10 wt. % AlN, about 10, 20, 30, 40, 50 to 50 wt. % Si₃N₄, about 0.1, 0.2 to 0.3 wt. % Al₂O₃, about 1, 2, 3, 4, 5, 6, 7, 8, 9 to 10 wt. % Yb₂O₃, about 1, 2, 3, 4, 5, 6, 7, 8, 9, 10, 11, 12, 13, 14, 15, 16 to 17 wt. % TiCN, about 1 to 1.5 wt. % h-BN, each wt. % based on the total weight of the second composition, and the core layer of the FG SiAlON composite includes about 0.1 to 0.2 wt. % SiO₂, about 1, 2, 3, 4, 5, 6, 7 to 8 wt. % AlN, about 10, 20, 30, 40 to 45 wt. % Si₃N₄, about 0.1, 0.2 to 0.25 wt. % Al₂O₃, about 1, 2, 3, 4, 5, 6, 7, 8 to 9.0 wt. % Yb₂O₃, about 1, 5, 7, 9, 10, 12, 14, 16, 18, 20, 22, 24, 26, 28 30 to 31.500 wt. % TiCN, each wt. % based on the total weight of the third composition. Other ranges are also possible.

In some embodiments, the bottom layer and the top layer of the FG SiAlON composite includes about 0.31 wt. % SiO₂, about 11.62 wt. % AlN, about 63.74 wt. % Si₃N₄, about 0.35 wt. % Al₂O₃, about 11.80 wt. % Yb₂O₃, about 9.18 wt. % TiCN, about 3.01 wt. % h-BN, each wt. % based on the total weight of the first composition. Further, the first inner layer and the second inner layer of the FG SiAlON composite includes about 0.28 wt. % SiO₂, about 10.68 wt. % AlN, about 58.65 wt. % Si₃N₄, about 0.32 wt. % Al₂O₃, about 10.85 wt. % Yb₂O₃, about 17.48 wt. % TiCN, about 1.72 wt. % h-BN, each wt. % based on the total weight of the second composition, and the core layer of the FG SiAlON composite includes about 0.24 wt. % SiO₂, about 8.99 wt. % AlN, about 49.36 wt. % Si₃N₄, about 0.27 wt. % Al₂O₃, about 9.13 wt. % Yb₂O₃, about 32.00 wt. % TiCN, each wt. % based on the total weight of the third composition.

In some embodiments, the FG SiAlON composite has a density of about 2 to 5 grams per cubic centimeter (g/cm³), preferably 2.5 to 4.5 g/cm³, preferably 3 to 4 g/cm³, or even more preferably about 3.725 g/cm³. In some embodiments, the FG SiAlON composite has a thermal conductivity of 2 to 10 watts per meter kelvin (W/mK), preferably 3 to 9 W/mK, preferably 4 to 8 W/mK, preferably 4.5 to 7 W/mK, or even more preferably 4.8 to 6.3 W/mK. In some embodiments, the FG SiAlON composite has a thermal expansion coefficient of 1 to 5 fractional change in length per degree Celsius (μ/° C.), preferably 2 to 4 μ/° C., preferably 3 to 3.5 μ/° C., or even more preferably 3.1 to 3.5 μ/° C. In some preferred embodiments, the FG SiAlON composite has a density of about 3.725 g/cm³; a thermal conductivity of 4.8 to 6.3 W/mK; and a thermal expansion coefficient of 3.1 to 3.5 μ/° C. Other ranges are also possible.

In some embodiments, the bottom layer and the top layer of the FG SiAlON composite include about 0.10, 0.20 to 0.30 wt. % SiO₂, about 3, 6, 9 to 12 wt. % AlN, about 10, 20, 30, 40, 50, 60 to 65 wt. % Si₃N₄, about 0.1 to 0.3 wt. % Al₂O₃, about 1, 2, 3, 4, 5, 6, 7, 8, 9, 10, 11 to 12 wt. % Yb₂O₃, about 1, 2 to 2.5 wt. % Co, about 1, 2, 3 to 3.05 wt. % h-BN, each wt. % based on the total weight of the first composition. In some embodiments, the first inner layer and the second inner layer of the FG SiAlON composite about 0.11, 0.22 to 0.30 wt. % SiO₂, about 1, 2, 3, 4, 5, 6, 7, 8, 9, 10, 11 to 12 wt. % AlN, about 10, 20, 30, 40, 50, 60 to 65 wt. % Si₃N₄, about 0.1, 0.2 to 0.30 wt. % Al₂O₃, about 1, 2, 3, 4, 5, 6, 7, 8, 9, 10, 11 to 12 wt. % Yb₂O₃, about 1, 2, 3, 4 to 5 wt. % Co, about 1, 1.2, 1.3, 1.4, 1.5, 1.6, 1.7 to 1.80 wt. % h-BN, each wt. % based on the total weight of the second composition. In some embodiments, the core layer of the FG SiAlON composite includes about 0.1, 0.2 to 0.30 wt. % SiO₂, about 1, 2, 3, 4, 5, 6, 7, 8, 9, 10, 11 to 11.05 wt. % AlN, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64 to 65 wt. % Si₃N₄, about 0.1, 0.2, 0.3 to 0.35 wt. % Al₂O₃, about 1, 2, 3, 4, 5, 6, 7, 8, 9, 10, 11 to 12 wt. % Yb₂O₃, about 1, 2, 3, 4, 5, 6, 7, 8, 9 to 9.5 wt. % Co, each wt. % based on the total weight of the third composition.

In some embodiments, the FG SiAlON composite has a density of 2 to 5 g/cm³, preferably 2.5 to 4.5 g/cm³, preferably 3 to 4 g/cm³, or even more preferably about 3.575 g/cm³·g/cm³. In some embodiments, the FG SiAlON composite has a thermal conductivity of 2 to 10 W/mK, preferably 3 to 9 W/mK, preferably 3.5 to 8 W/mK, preferably 4 to 6 W/mK, or even more preferably 4.4 to 4.8 W/mK. In some embodiments, the FG SiAlON composite has a thermal expansion coefficient of 1 to 5 μ/° C., preferably 2 to 4 μ/° C., preferably 2.5 to 3.0 μ/° C., or even more preferably 2.6 to 3.0 μ/° C. Other ranges are also possible.

In some embodiments, the bottom layer and the top layer of the FG SiAlON composite includes about 0.33 wt. % SiO₂, about 12.47 wt. % AlN, about 68.43 wt. % Si₃N₄, about 0.37 wt. % Al₂O₃, about 12.66 wt. % Yb₂O₃, about 2.62 wt. % Co, about 3.10 wt. % h-BN, each wt. % based on the total weight of the first composition; the first inner layer and the second inner layer of the FG SiAlON composite includes about 0.33 wt. % SiO₂, about 12.31 wt. % AlN, about 67.55 wt. % Si₃N₄, about 0.36 wt. % Al₂O₃, about 12.50 wt. % Yb₂O₃, about 5.13 wt. % Co, about 1.81 wt. % h-BN, each wt. % based on the total weight of the second composition. The core layer of the FG SiAlON composite contains about 0.32 wt. % SiO₂, about 11.93 wt. % AlN, about 65.45 Wt. % Si₃N₄, about 0.36 wt. % Al₂O₃, about 12.11 wt. % Yb₂O₃, about 9.84 wt. % Co, each wt. % based on the total weight of the third composition. In some embodiments, the FG SiAlON composite has a density of about 3.575 g/cm³; a thermal conductivity of 4.4 to 4.8 W/mK; and a thermal expansion coefficient of 2.6 to 3.0 μ/° C. Other ranges are also possible.

In some other embodiments, the bottom layer and the top layer of the FG SiAlON composite includes about 0.1, 0.2 to 0.30 wt. % SiO₂, about 1, 2, 3, 4, 5, 6, 7, 8, 9, 10, 11 to 12.0 wt. % AlN, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67 to 68 wt. % Si₃N₄, about 0.1, 0.2 to 0.30 wt. % Al₂O₃, about 1, 2, 3, 4, 5, 6, 7, 8, 9, 10, 11 to 12 wt. % Yb₂O₃, about 1, 2 to 2.40 wt. % Co212-C, about 1, 2 to 3.0 wt. % h-BN, each wt. % based on the total weight of the first composition; the first inner layer and the second inner layer of the FG SiAlON composite includes about 1.0, 2.0 to 0.30 wt. % SiO₂, about 1, 2, 3, 4, 5, 6, 7, 8, 9, 10, 11 to 12 wt. % AlN, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 6 to 67 wt. % Si₃N₄, about 0.1, 0.2 to 0.3 wt. % Al₂O₃, about 1, 2, 3, 4, 5, 6, 7, 8, 9, 10, 11 to 12.0 wt. % Yb₂O₃, about 1, 2, 3 to 4.80 wt. % Co212-C, about 1.82 wt. % h-BN, each wt. % based on the total weight of the second composition. The core layer of the FG SiAlON composite includes about 0.32 wt. % SiO₂, about 11.99 wt. % AlN, about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 6 to 67.81 wt. % Si₃N₄, about 0.36 wt. % Al₂O₃, about 1, 2, 3, 4, 5, 6, 7, 8, 9, 10, 11, 12.0 wt. % Yb₂O₃, about 1, 2, 3, 4, 5, 6, 7, 8, 9.0 wt. % Co212-C, each wt. % based on the total weight of the third composition. In some examples, the FG SiAlON composite has a density of about 1, 2, 3 to 3.5 g/cm³; a thermal conductivity of 3.0 to 4.3 W/mK; and a thermal expansion coefficient of 2.8 to 3.0 μ/° C. Other ranges are also possible.

In some other embodiments, the bottom layer and the top layer of the FG SiAlON composite includes about 0.33 wt. % SiO₂, about 12.49 wt. % AlN, about 68.54 wt. % Si₃N₄, about 0.37 wt. % Al₂O₃, about 12.68 wt. % Yb₂O₃, about 2.48 wt. % Co212-C, about 3.10 wt. % h-BN, each wt. % based on the total weight of the first composition. The first inner layer and the second inner layer of the FG SiAlON composite includes about 0.33 wt. % SiO₂, about 12.34 wt. % AlN, about 67.74 wt. % Si₃N₄, about 0.37 wt. % Al₂O₃, about 12.53 wt. % Yb₂O₃, about 4.86 wt. % Co212-C, about 1.82 wt. % h-BN, each wt. % based on a total weight of the second composition. The core layer of the FG SiAlON composite includes about 0.32 wt. % SiO₂, about 11.99 wt. % AlN, about 65.81 wt. % Si₃N₄, about 0.36 wt. % Al₂O₃, about 12.18 wt. % Yb₂O₃, about 9.33 wt. % Co212-C, each wt. % based on a total weight of the third composition. Other ranges are also possible.

In some embodiments, the FG SiAlON composite has a density of 2 to 5 g/cm³, preferably 2.5 to 4.5 g/cm³, preferably 3 to 4 g/cm³, or even more preferably about 3.566 g/cm³·g/cm³. In some embodiments, the FG SiAlON composite has a thermal conductivity of 2 to 10 W/mK, preferably 2.5 to 8 W/mK, preferably 3 to 6 W/mK, preferably 3.5 to 5 W/mK, or even more preferably 3.8 to 4.4 W/mK. In some embodiments, the FG SiAlON composite has a thermal expansion coefficient of 1 to 5 μ/° C., preferably 2 to 4 μ/° C., preferably 2.5 to 3.5 μ/° C., or even more preferably 2.7 to 3.1 μ/° C. In some preferred examples, the FG SiAlON composite has a density of about 3.566 g/cm³; a thermal conductivity of 3.8 to 4.4 W/mK; and a thermal expansion coefficient of 2.7 to 3.1 μ/° C. Other ranges are also possible.

In some embodiments, the cutting surface of the FG SiAlON composite cutting tool shows improved thermomechanical and tribological properties compared to a cutting surface of a SiAlON composite cutting tool in the absence of the one or more reinforcement additives. In some embodiments, the density of the FG SiAlON composite is at least 5% higher, preferably at least 10% higher, preferably at least 20% higher, preferably at least 40% higher, preferably at least 80% higher, or even more preferably at least 100% higher than the density of a SiAlON composite in the absence of the one or more reinforcement additives. In some embodiments, the thermal conductivity of the FG SiAlON composite is at least 5% higher, preferably at least 25% higher, preferably at least 50% higher, preferably at least 100% higher, preferably at least 200% higher, or even more preferably at least 400% higher than the thermal conductivity of a SiAlON composite in the absence of the one or more reinforcement additives. In some embodiments, the thermal expansion coefficient of the FG SiAlON composite is at least 5% higher, preferably at least 25% higher, preferably at least 50% higher, preferably at least 100% higher, preferably at least 200% higher, or even more preferably at least 400% higher than the thermal expansion coefficient of a SiAlON composite in the absence of the one or more reinforcement additives. In some embodiments, the fracture toughness of the FG SiAlON composite is at least 5% higher, preferably at least 25% higher, preferably at least 50% higher, preferably at least 100% higher, preferably at least 200% higher, or even more preferably at least 400% higher than the fracture toughness of a SiAlON composite in the absence of the one or more reinforcement additives. In some embodiments, the elasticity of the FG SiAlON composite is at least 5% higher, preferably at least 25% higher, preferably at least 50% higher, preferably at least 100% higher, preferably at least 200% higher, or even more preferably at least 400% higher than the elasticity of a SiAlON composite in the absence of the one or more reinforcement additives. Other ranges are also possible.

The crystalline structure of A1 (pure Yb₂O₃-doped SiAlON), A2 (Yb₂O₃-doped SiAlON with 4 vol % of 2 μm Co), A3 (FG TiCN and hBN in a Yb₂O₃-doped SiAlON matrix), A4 (FG 2 μm Cobalt and hBN in a Yb₂O₃-doped SiAlON matrix), A5 (FG 32 μm Cobalt and hBN in a Yb₂O₃-doped SiAlON matrix), A6 (Yb₂O₃-doped SiAlON with 20 vol % of TiCN), A7 (Yb₂O₃-doped SiAlON with 4 vol % of 32 μm Co) is characterized by X-ray diffraction (XRD). In some embodiments, the XRD patterns are collected in a Rigaku Miniflex 600 X-ray diffractometer equipped with a Cu-Kα radiation source (λ=1.5406 Å) for a 2θ range extending between 10 and 900, preferably 20 and 700, further preferably 30 and 500 at an angular rate of 0.005 to 0.04° s⁻¹, preferably 0.01 to 0.03° s⁻¹, or even preferably 0.02° s⁻¹.

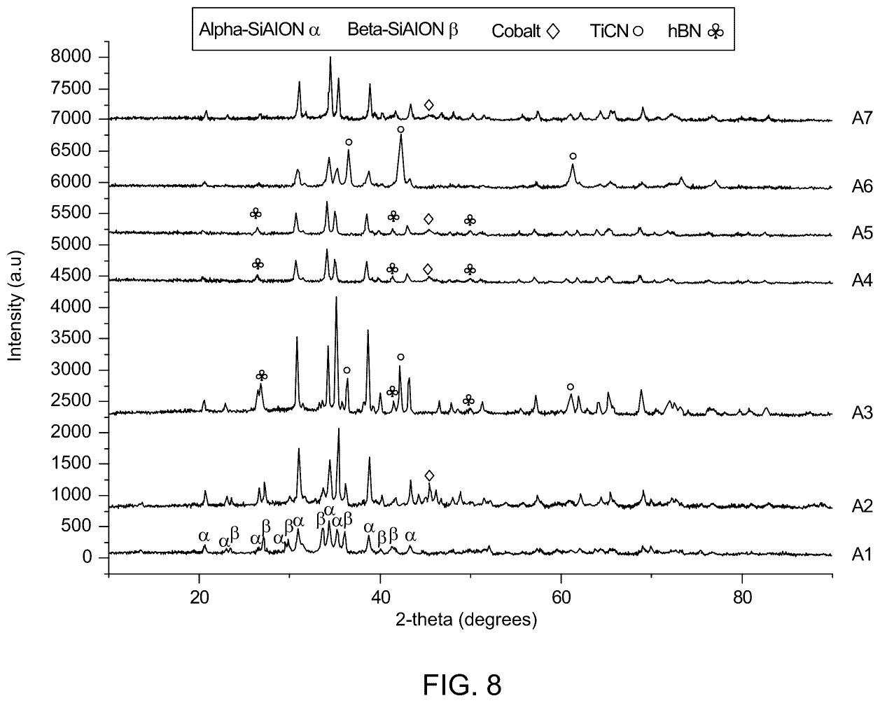

In some embodiments, the A1 (pure Yb₂O₃-doped SiAlON) has peaks with a 2θ value of about 20 to 23°, about 23.0 to 30°, about 30 to 38°, about 39 to 43°, about 52 to 55°, and 65 to 70° in the XRD spectrum, as depicted in FIG. 8. In some embodiments, the A2 (Yb₂O₃-doped SiAlON with 4 vol % of 2 μm Co) has peaks with a 2θ value of about 20 to 23°, about 23.0 to 30°, about 30 to 38°, about 38 to 40°, about 40 to 47°, and 51 to 54° in the XRD spectrum, as depicted in FIG. 8. In some embodiments, the A3 (FG TiCN and hBN in a Yb₂O₃-doped SiAlON matrix) has peaks with a 2θ value of about 20 to 23°, about 23.0 to 25°, about 25 to 28°, about 31 to 34°, about 34 to 38°, about 38 to 40°, about 40 to 45°, about 45 to 50°, about 50 to 52°, about 57 to 60°, about 60 to 65°, about 65 to 70°, and about 70 to 75° in the XRD spectrum, as depicted in FIG. 8. In some embodiments, the A4 (FG 2 μm Cobalt and hBN in a Yb₂O₃-doped SiAlON matrix) has peaks with a 2θ value of about 25 to 28°, about 31 to 34°, about 34 to 38°, about 38 to 40°, about 40 to 45°, about 45 to 50°, about 50 to 52°, about 57 to 60°, about 60 to 65°, about 65 to 70°, and about 70 to 750 in the XRD spectrum, as depicted in FIG. 8. In some embodiments, the A5 (FG 32 μm Cobalt and hBN in a Yb₂O₃-doped SiAlON matrix) has peaks with a 2θ value of about 25 to 28°, about 31 to 34°, about 34 to 36°, about 36 to 39°, about 40 to 45°, about 45 to 50°, about 50 to 60°, about 60 to 65°, about 65 to 70°, and about 70 to 75° in the XRD spectrum, as depicted in FIG. 8. In some embodiments, the A7 (Yb₂O₃-doped SiAlON with 4 vol % of 32 μm Co) has peaks with a 2θ value of about 31 to 34°, about 34 to 36°, about 36 to 39°, about 40 to 45°, about 55 to 65°, about 65 to 70°, and about 70 to 75° in the XRD spectrum, as depicted in FIG. 8. In some embodiments, the A6 (Yb₂O₃-doped SiAlON with 20 vol % of TiCN) has peaks with a 2θ value of about 31 to 34°, about 34 to 36°, about 36 to 39°, about 40 to 45°, about 60 to 65°, about 65 to 70°, and about 70 to 75° in the XRD spectrum, as depicted in FIG. 8. In yet some other embodiments, pattern peaks in the XRD spectrum of FIG. 8 confirm the presence of β-phase SiAlON, α-phase SiAlON, Co, TiCN, and hBN structures. Other ranges are also possible.

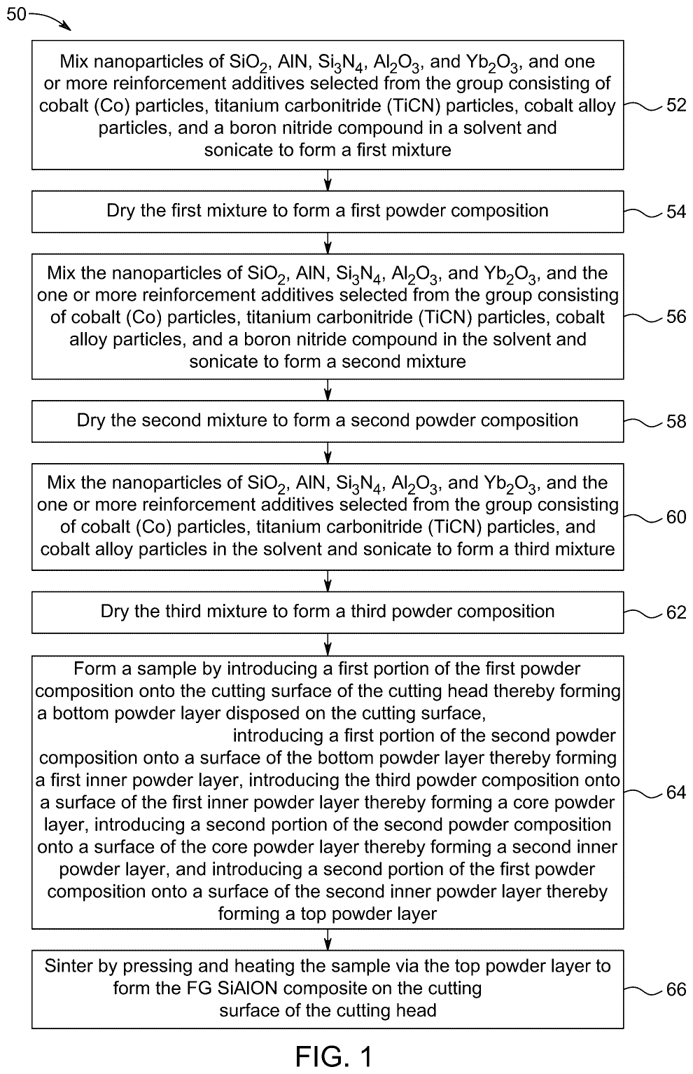

FIG. 1 illustrates a flow chart of a method 50 of preparing the FG SiAlON composite. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes mixing nanoparticles of SiO₂, AlN, Si₃N₄, Al₂O₃, and Yb₂O₃, and one or more reinforcement additives selected from the group consisting of cobalt (Co) particles, titanium carbonitride (TiCN) particles, cobalt alloy particles, and a boron nitride compound in a solvent and sonicate to form a first mixture. The solvent is a combination of the alcohols selected from the group consisting of methanol, ethanol, and propanol. In some embodiments, the solvent also contains a mixture of non-alcoholic and alcoholic compounds or derivatives thereof. In some embodiments, the non-alcoholic compound is water or a mixture including water. In some embodiments, the sonication is preferably an ultrasonication performed via a probe sonicator. In some embodiments, the sonication is performed for 20 minutes to 12 hours, preferably 1 to 10 hours, preferably 2 to 8 hours, preferably 3 to 6 hours. In some preferred embodiments, the sonication is performed for 4 hours. Other ranges are also possible.

At step 54, the method 50 includes drying the first mixture to form a first powder composition. In some embodiments, the drying is done in a vacuum at 20 to 100° C. for about 24 to 48 hours. In some preferred embodiments, the drying is done in a vacuum at 60° C. for about 24 hours.

At step 56, the method 50 includes mixing the nanoparticles of SiO₂, AlN, Si₃N₄, Al₂O₃, and Yb₂O₃, and the one or more reinforcement additives selected from the group consisting of cobalt (Co) particles, titanium carbonitride (TiCN) particles, cobalt alloy particles, and a boron nitride compound in the solvent and sonicate to form a second mixture. In some embodiments, the sonication is preferably an ultrasonication performed via a probe sonicator. In some embodiments, the sonication is performed for 20 minutes to 12 hours, preferably 1 to 10 hours, preferably 2 to 8 hours, preferably 3 to 6 hours. In some preferred embodiments, the sonication is performed for 4 hours. Other ranges are also possible.

At step 58, the method 50 includes drying the second mixture to form a second powder composition. In some embodiments, the drying is done in a vacuum at 20 to 100° C. for about 24 to 48 hours. In some preferred embodiments, the drying is done in a vacuum at 60° C. for about 24 hours.

At step 60, the method 50 includes mixing the nanoparticles of SiO₂, AlN, Si₃N₄, Al₂O₃, and Yb₂O₃, and the one or more reinforcement additives selected from the group consisting of cobalt (Co) particles, titanium carbonitride (TiCN) particles, and cobalt alloy particles in the solvent and sonicating to form a third mixture. In some embodiments, the sonication is preferably an ultrasonication performed via a probe sonicator. In some embodiments, the sonication is performed for 20 minutes to 12 hours, preferably 1 to 10 hours, preferably 2 to 8 hours, preferably 3 to 6 hours. In some preferred embodiments, the sonication is performed for 4 hours. Other ranges are also possible.

At step 62, the method 50 includes drying the third mixture to form a third powder composition. In some embodiments, the drying is done in a vacuum at 20 to 100° C. for about 24 to 48 hours. In some preferred embodiments, the drying is done in a vacuum at 60° C. for about 24 hours.

At step 64, the method 50 includes forming a sample including 5 layers of 3 symmetrical compositions. The sample is formed by introducing a first portion of the first powder composition on to the cutting surface of the cutting head thereby forming a bottom powder layer disposed on the cutting surface, followed by introducing a first portion of the second powder composition onto a surface of the bottom powder layer, thereby forming a first inner powder layer. Next, the method includes introducing the third powder composition onto a surface of the first inner powder layer thereby, forming a core powder layer, and then introducing a second portion of the second powder composition onto a surface of the core powder layer, thereby forming a second inner powder layer, and finally introducing a second portion of the first powder composition onto a surface of the second inner powder layer thereby forming a top powder layer.

At step 66, the method 50 includes sintering by pressing and heating the sample via the top powder layer to form the FG SiAlON composite on the cutting surface of the cutting head. In some embodiments, the FG SiAlON composite comprises 5 layers of 3 symmetrical compositions and have a total thickness (T). In some embodiments, the sintering to form the FG SiAlON composite is selected from a group consisting of spark plasma sintering (SPS), heat press sintering, and hybrid sintering. In a preferred embodiment, the sintering to form the FG SiAlON composite is SPS.

In some embodiments, the pressing is performed under a uniaxial pressure in a range of 30 to 70 megaPascals (MPa). In some embodiments, the uniaxial pressure in a range of 31, preferably 32, preferably 33, preferably 34, preferably 35, preferably 36, preferably 37, preferably 38, preferably 39, preferably 40, preferably 41, preferably 42, preferably 43, preferably 44, preferably 45, preferably 46, preferably 47, preferably 48, preferably 49, preferably 50, preferably 51, preferably 52, preferably 53, preferably 54, preferably 55, preferably 56, preferably 57, preferably 58, preferably 59, preferably 60, preferably 61, preferably 62, preferably 63, preferably 64, preferably 65, preferably 65, preferably 66, preferably 67, preferably 68, preferably 69 megaPascals (MPa). Other ranges are also possible.

In some embodiments, the heating is performed at a temperature in a range of 1400 to 1600° C. In some embodiments, the heating is performed at a temperature in a range of 1400, preferably 1430, preferably 1440, preferably 1445, preferably 1450, preferably 1460, preferably 1465, preferably 1470, preferably 1475, preferably 1480, preferably 1485, preferably 1490, preferably 1495, preferably 1500, preferably 1505, preferably 1510, preferably 1515, preferably 1520, preferably 1525, preferably 1530, preferably 1535, preferably 1540, preferably 1545, preferably 1555, preferably 1565, preferably 1575, preferably 1585, preferably 1590, preferably 1595 or about 1597° C. Other ranges are also possible.

The FG SiAlON composite prepared by the method of the present disclosure has a layered structure and a total thickness (T). The layered structure of the FG SiAlON composite includes a bottom layer above and adjacent to the cutting surface of the cutting head, a first inner layer above and adjacent to the bottom layer, a first inner layer above and adjacent to the bottom layer, a core layer above and adjacent to the first inner layer, a second inner layer above and adjacent to the core layer, and a top layer above and adjacent to the second inner layer. The bottom layer and the top layer have the same first thickness (t₁); the first inner layer and the second inner layer have the same second thickness (t₂); the core layer has a third powder composition and a core thickness (t_{c}); wherein 2×t₁+2×t₂+t_{c}=T. The first ratio of t₁ to T is about 0.08; the second ratio of t₂ to T is about 0.17; and the third ratio of t_{c} to T is about 0.5.

In some embodiments, the FG SiAlON composite prepared by the method of the present disclosure is monolithic α-phase SiAlON. In some embodiments, the FG SiAlON composite prepared by the method of the present disclosure is monolithic β-phase SiAlON. In some further embodiments, the FG SiAlON composite prepared by the method of the present disclosure contains a mixture of α-phase SiAlON and β-phase SiAlON. In some preferred embodiments, a ratio of α-phase SiAlON and β-phase SiAlON present in the FG SiAlON composite ranges from 100:1 to 1:100, preferably 1:80 to 80:1, preferably 1:60 to 60:1, preferably 1:40 to 40:1, preferably 1:20 to 20:1, preferably 1:10 to 10:1, or even more preferably about 1:1, as determined by XRD analysis. Other ranges are also possible.

### Examples

The following examples demonstrate a functionally graded (FG) SiAlON composite-cutting tool, as described herein. The examples are provided solely for illustration and are not to be construed as limitations of the present disclosure, as many variations thereof are possible without departing from the spirit and scope of the present disclosure.

### Example 1: Materials

Functionally graded SiAlON (i.e., FG SiAlON or FG-SiAlON) composite contains inhomogeneities at two different scales, i.e., mesoscale and macroscale. The mean field homogenization theories are used to estimate the effective properties of the respective composite layers using optimum reinforcement material volume fractions, porosity, and interfacial properties. Then, numerical simulations formulated using computational homogenization theories were used to optimize the number of layers required to achieve the desired structural and thermal properties for the functionally graded (FG) composite. Due to its desirable thermo-mechanical properties, the Yb₂O₃-doped SiAlON matrix was selected as the material of the matrix. The Yb₂O₃-doped SiAlON properties are enhanced by adding a single inclusion from various material types, volume fractions, and particle sizes while assuming the uniform dispersion of the reinforcement particles. Multiple combinations of metallic and ceramic reinforcement materials were chosen for the test. Three metallic inclusion materials, i.e., Co, TiCN, and Co212, are incorporated due to their desirable thermo-structural properties. Hexagonal boron nitride (hBN) was incorporated as the self-lubricating agent, which is critically needed at the topmost layers. For validation, several composite samples were fabricated via the powder lamination technique. The effective properties of the synthesized samples were measured using various experimental/analytical tools. Effective combinations of material parameters for developing FG-SiAlON composite with properties tailored for enduring high-speed cutting operations were disclosed.

### Example 2: Computational Calculation of Individual Composite Layer Properties

Mean field homogenization refers to a method of effective properties calculation for inhomogeneous materials using micro-mechanic-based equations. The approach works by finding a solution to a microscale problem over a representative volume of the heterogeneous material. Then, averaging is done over multiple microscale solutions to calculate the macroscale response of the heterogeneous material. For the examples provided in the present disclosure, an effective medium theory for composites with numerous inclusions was used to calculate the thermo-mechanical properties of the SiAlON-based FG composite. The model considers the properties of the matrix and each of the inclusions, along with the particle size, interfacial thermal resistance, and volume fractions of the constituents. The inclusions are either spherical or flake-like shapes. The inclusions were considered to be fully dispersed, so no crossover interaction exists between temperature distribution and strain fields. The following equations (Eq. 1-10) express the effective mean theory used to calculate the effective thermal conductivity of each composite layer (as shown in FIG. 2), [M. U. Siddiqui, A. Fazal, M. Arif, Generalized Effective Medium Theory for Particulate Nanocomposite Materials, 2016, which is incorporated herein by reference in its entirety].

$${K}_{ef , 11} = \qquad ( 1 )$$

$${K}_{ef , 22} = {K}_{mat} \frac{2 + {\sum }_{i = 1}^{N} {φ}_{i} [ {β}_{11}^{i} ( 1 - {L}_{11}^{i} ) ( 1 + {〈 θ 〉}^{i} ) + {β}_{33}^{i} ( 1 - {L}_{33}^{i} ) ( 1 - {〈 θ 〉}^{i} ) ]}{2 - {\sum }_{i = 1}^{N} {φ}_{i} [ {β}_{11}^{i} {L}_{11}^{i} ( 1 + {〈 θ 〉}^{i} ) + {β}_{33}^{i} {{L}_{33}^{i} ( 1 - 〈 θ 〉 )}^{i} ]}$$

$${K}_{ef , 33} = {K}_{mat} \frac{1 + {\sum }_{i = 1}^{N} {φ}_{i} [ {β}_{11}^{i} ( 1 - {L}_{11}^{i} ) ( 1 - {〈 θ 〉}^{i} ) + {β}_{33}^{i} ( 1 - {L}_{33}^{i} ) ( {〈 θ 〉}^{i} ) ]}{1 - {\sum }_{i = 1}^{N} {φ}_{i} [ {β}_{11}^{i} {L}_{11}^{i} ( 1 - {〈 θ 〉}^{i} ) + {β}_{33}^{i} {L}_{33}^{i} {〈 θ 〉}^{i} ]} \qquad ( 2 )$$

Here: K_{ef,11}, K_{ef,22} and K_{ef,33} represents the effective thermal conductivities of each composite the x, y, and z directions, φᵢ is the inclusion volume fraction, a₁ and a₃ are particle radii,

$${α}_{k}^{i} = \frac{{R}_{TB}^{i} {K}_{m}}{{a}_{k}^{i}} , {β}_{kk}^{i} = \frac{{K}_{c , kk}^{i} - {K}_{m}}{{K}_{m} + {L}_{kk}^{i} ( {K}_{c , kk}^{i} - {K}_{m} )} ,$$

R_{TB}ⁱ is the interfacial thermal resistance, pⁱ=a₃ⁱ/a₁ⁱ is the aspect ratio, K_{inc} is the thermal conductivity of inclusion of type i, <θ≥ⁱ is the factor which defines the orientation of inclusion of type i, Kₘ is the thermal conductivity of the base matrix material. Further details about the model can be found in Siddiqui et al. The effective thermal expansion coefficient of each layer in the FG composite (FIG. 2) is calculated using the Mori-Tanaka mean-field homogenization theory:

$${α}_{eff} = {α}_{i} {I}_{2} + {c}_{i} ( {C}_{i}^{- 1} - {C}_{M}^{- 1} ) {W ( ( 1 - {c}_{i} ) {I}_{4} + {c}_{i} W )}^{- 1} {( {C}_{i}^{- 1} - {C}_{M}^{- 1} )}^{- 1} ( {∝}_{i} {I}_{2} - {α}_{M} {I}_{2} ) \qquad ( 3 )$$

$$W = {C}_{i} {A}_{i} {C}_{M}^{- 1} ( 2.2 ) {A}_{i} = {[ I + {S}_{M} {C}_{M}^{- 1} ( {C}_{I , i} - {C}_{M} ) ]}^{- 1} \qquad ( 4 )$$

α_{eff} is the effective thermal expansion coefficient of the composite layer, α_{M} is the thermal expansion coefficient of the base matrix material, while ∝ᵢ is the thermal expansion coefficient of the reinforcement, C_{M} is the stiffness tensor of the base matrix, C_{I} is the stiffness tensor of the inclusion, and S is the Eshelby tensor. Cᵢ is the inclusion volume fraction. I₂ and I₄ are the second and fourth stiffness tensors, respectively. Aᵢ is the strain localization tensor for the inclusion type i which is determined by the Mori-Tanaka scheme [Y. Xu, Y. Tanaka, M. Goto, Thermal conductivity of SiC fine particles reinforced A1 alloy matrix composite with dispersed particle size, J Appl Phys., 2004, 95, 722, which is incorporated herein by reference in its entirety].

The elastic modulus is computed through the Eshelby's model of 1965, along with the mean-field homogenization method by the Voigt method. Using strain localization, the macro-scale strain is related to the micro-scale with the following equation:

$$E ( x ) = A ( x ) {\overline{E}}_{M} \qquad ( 5 )$$

$${\overline{C}}_{M} = {\sum }_{i} {c}_{i} {A}_{i} \qquad ( 6 )$$

The homogenized elasticity tensor is computed by:

$${\overline{C}}_{M} = {\sum }_{i} {c}_{i} {A}_{i} \qquad ( 7 )$$

It is further resolved by the Mori-Tanaka scheme:

$${A}_{( MT ) , i} = {[ {c}_{i} I + {{c}_{m} ( {A}_{i} )}^{- 1} + {\sum }_{j} {c}_{i} {{A}_{j} ( {A}_{i} )}^{- 1} ]}^{- 1} \qquad ( 8 )$$

Finally, the mean-field homogenization is computed through the Voigt equation:

$${\overline{C}}_{eff} = {\sum }_{i = 1}^{N} \frac{{c}_{i}^{i}}{1 - {c}_{m}} {c}_{eff}^{i} \qquad ( 9 )$$

### Example 3: Computational Calculation of Functionally-Graded Composite Properties

The computational homogenization methodology relies on using an axisymmetric finite element model to calculate the effective properties of the FG composite structure via numerical integration of the assigned material properties over the volume of the inhomogeneous composite structure, which is in the form of disk-shaped samples (FIG. 2). The effective thermal conductivity of the FG structure is obtained from Fourier's law of heat conduction, i.e., qᵢᵢ=kᵢⱼT_{j,j} which relates the heat flux with the temperature gradient (here: T_{j,j} is the temperature gradient along direction j, k is the thermal conductivity tensor, and qᵢᵢ is the heat flux along direction i). Being a layered composite structure, the temperature difference required to calculate the required heat flux terms is only imposed along the thickness directions (as shown in FIG. 2). Then, the volume average of the heat flux along the two orthogonal directions is computed and inserted into Eq. (10) to estimate the effective thermal conductivity values.

$${k}_{ij} = \frac{1}{{T}_{j , j}} [ \frac{1}{V} {\int }_{V} {q}_{ii} dV ] \qquad ( 10 )$$

The Hooke's law (i.e., Eq. (11)) is used to calculate the effective elastic moduli of the FG structure. In its simplest form, stress (σᵢⱼ) is related to the strain tensor (εₖₗ) via a symmetric fourth-order stiffness tensor (Cᵢⱼₖₗ):

$${σ}_{ij} = {C}_{ijkl} {ε}_{kl} \qquad ( 11 )$$

For the layered composite structure, elastic constants were obtained through the compliance tensor S, after applying a unit strain along the thickness direction via the displacement boundary conditions. The compliance stiffness tensor from the average values of the stress tensor through:

$${S}_{iijj} = \overline{{σ}_{ij}} = \frac{1}{V} {\int }_{V} {σ}_{ij} ( {x}_{1} , {x}_{2} , {x}_{3} ) dV \qquad ( 12 )$$

The effective thermal expansion coefficient along the thickness direction was obtained from the calculated average stresses and strains developed when a unit temperature difference was imposed along the thickness direction. The constitutive equation that relates the thermal expansion coefficient with the elastic stiffness constants is:

$${C}_{ijkl} {σ}_{ij} + Δ T {α}_{kl} = 0 \qquad ( 13 )$$

where ΔT is the temperature difference, and αₖᵢ is the thermal expansion coefficient. Then, the effective thermal expansion coefficient is:

$${α}_{kl} = \frac{1}{Δ T} \overline{{ε}_{kl}} = \frac{1}{V} {\int }_{V} {ε}_{kl} dV \qquad ( 14 )$$

Since the computation codes only provide property calculation on a layer-by-layer basis, the finite element method is critical to calculating the effective properties across the thickness of the FG structure containing five layers. COMSOL Multiphysics software [COMSOL Inc., COMSOL Multiphysics, 2017] was used to calculate the effective thermal conductivity, elastic modulus, coefficient of thermal expansion, residual stress and elastic strain energy density in the FG composite structures adopting Eq. (10)-(14). A 2D axisymmetric geometry was utilized for the computations, and material properties are calculated for each layer inserted into the COMSOL code. A fixed boundary condition is imposed at the tool's base, and a temperature gradient of 13° C. was applied on both ends. A stationary solver is used to compute the solution for the heat transfer and solid mechanics models in which the material was assumed to be linearly elastic. From the interaction of these two models, a Multiphysics coupling is generated to calculate the effective thermal expansion coefficient of the composite. The residual stresses and the strain energy density developed as a result of the cooling the layered structure from the sintering temperature (i.e., 1500° C.) to the ambient conditions was also calculated using Eq. (10)-(14). As the mesh immensely affects the accuracy of the computation, the numerical results were carefully assessed for proper convergence with fine mesh throughout the geometry of layered structure. The numerical results show that the calculated properties for the composite structure become independent of grid size when 37,928 tetrahedral elements were utilized for the computation.

### Example 4: Experiments

Yb₂O₃-doped SiAlON was selected as the matrix material for all synthesized samples. The commercially available powders used to synthesize the matrix are: SiO₂ (20-50 nm, 99.5%, Sigma Aldrich, USA), AlN (<100 nm, Sigma Aldrich, USA), and Si₃N₄ (300-500 nm, 99% α-phase content, SN-E10, UBE Industries, Japan), Al₂O₃ (<100 nm, 99.97%, Chempur, Germany) and Yb₂O₃ (<100 nm, 99%, Chempur, Germany). The metal oxide, Yb₂O₃, was selected as the sintering additive with an M=1.3 and N=0.8 being the values that are used to calculate the mass ratios of the SiAlON precursors following the general formula of α-SiAlON M_{m/v}Si₂₋₍ₘ₊ₙ₎Alₘ₊ₙOₙN₁₆₋ₙ(here: M represents the rare earth element Yb). Commercially available reinforcement inclusion was used for the FG samples, which are: Co (2 μm, 99.8%, Sigma-Aldrich, USA), TiCN (1.45 μm, 99.8%, Sigma-Aldrich, USA), Co212-C (32 μm, 99.8%, Sandvik Osperey, United Kingdom) and h-BN (70 nm×2 μm, 99%, Chempur, Germany).

The Co, TiCN, and Co212 reinforcements are added to tune the fracture toughness, thermal conductivity, and thermal expansion coefficient of the FG composite. At the same time, h-BN inclusions serve as a solid lubricant added only to the topmost layer regions. The hexagonal boron nitride (h-BN) was weighed and dispersed in water, followed by ultrasonication (for 4 hours) using a probe sonicator to exfoliate h-BN. The resultant suspension was centrifuged at 3000 rpm for 15 minutes to remove the aggregated and unexfoliated h-BN. The supernatant was centrifuged again at 15000 rpm for 15 minutes, and the powder was collected and dried at 60° C. for 24 hours under a vacuum oven. For functionalization of h-BN using polyethyleneimine (PEI), 4 g of exfoliated h-BN powder was dispersed in 500 ml of 2 wt % ethanol PEI solution and sonicated in a bath sonicator. After about 8 hours, the suspension was centrifuged thrice at 15000 rpm for 15 minutes with water to remove the unreacted PEI. Finally, the product was collected and dried under a vacuum (at 60° C. and for about 24 hours) to obtain the functionalized h-BN (PEI-BN).

Ethanol was added to the carefully weighed powders and was mixed using a probe sonicator (VCX 750, Sonics, USA). Each mixture was left in the sonicator for at least 20 minutes. For powders containing functionalized hBN, the sonication was done for 40 minutes. Subsequently, drying in an oven was done at approximately 80 C for 24 hours to evaporate the added ethanol. Each layer mixture for the FG samples and the bulk sample powders was mixed in a mortar and pestle. Each layer was carefully packed to a 20 mm graphite die. All samples were synthesized using spark plasma sintering (SPS) equipment (HP D5, FCT Systeme, Germany) under a uniaxial pressure of 50 MPa and a cooling and heating rate of 100° C./min. The soaking temperature was 1500° C. for 30 minutes [A. S. Hakeem, R. M. A. Khan, M. M. Al-Malki, F. Patel, A. I. Bakare, S. Ali, S. Hampshire, T. Laoui, Development and Processing of SiAlON Nano-Ceramics by Spark Plasma Sintering, Advances in Science and Technology. 2014, 89, 63-69; A. S. Hakeem, M. Khan, B. A. Ahmed, A. Al Ghanim, F. Patel, M. A. Ehsan, S. Ali, T. Laoui, S. Ali, Synthesis and characterization of alkaline earth and rare earth doped sialon Ceramics by spark plasma sintering, Int J Refract Metals Hard Mater. 2021, 97, 105500; B. A. Ahmed, A. S. Hakeem, T. Laoui, M. Al Malki, M. A. Ehsan, S. Ali, Low-temperature spark plasma sintering of calcium stabilized alpha sialon using nano-size aluminum nitride precursor, Int J Refract Metals Hard Mater., 2018, 71, 301-306, each of which is incorporated herein by reference in their entireties].

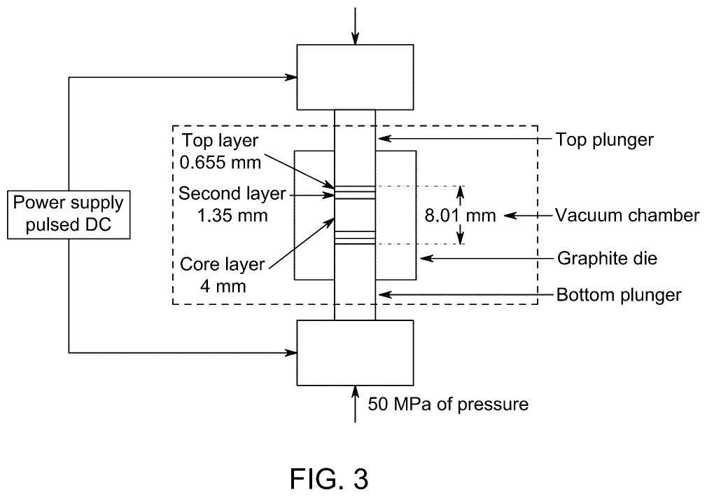

Referring to FIG. 3, an illustration of the SPS process and how the layers were stacked is shown. Seven different samples were synthesized by SPS while maintaining the same process parameters. Four bulk samples were synthesized; A1 is a pure Yb₂O₃-doped SiAlON sample, and A2, A6, and A7 represent the core of the FG samples A3, A4, and A5, respectively. The bulk samples are studied to investigate the effect of the reinforcing inclusions, i.e., TiCN, Co, and Co212, on the effective properties of the respective core layers that make most of the FG composite. The FG samples (i.e., A3, A4, and A5) are also synthesized through SPS adopting the powder lamination method as demonstrated in FIG. 3. Mechanical properties in FG structure are attained when the layer thickness ratio is around 0.3; thus, resulting in the layer thicknesses: 4.00 mm, 1.35 mm and 0.40 mm. However, to achieve improved layering profiles after the SPS, the thickness of the outer layer is increased to 0.655 mm after grinding and polishing (instead of 0.4 mm). Extensive grinding and polishing were carried out to remove the graphite bonded to the surface of the samples and to prepare for further tests and experiments. SiC abrasive paper (grit 60 to 1200) was used, followed by polishing with alumina suspension (particle size 150 nm).

Field emission scanning electron microscope was used to investigate the microstructure of the synthesized samples (FESEM, Lyra3, Tescan, Czech Republic) equipped with an energy-dispersive X-ray spectrometer (EDXS, X-MaxN silicon drift detector, Oxford Instruments, UK). The molecular disorientation and band characteristics were observed by a Raman microscope (Thermo Scientific, DXR2, Boston, MA, USA) with an excitation wavelength of 455 nm and laser power of 2.5 mW. The spectra were obtained at room temperature. X-ray diffraction (XRD, MiniFlex, Rigaku, Japan) was carried out for phase analysis of all synthesized samples. The diffractometer was operated at a 0.15416 nm wavelength, 10 mA current, and 30 kV voltage.

The relative density of the samples was estimated using the Archimedes principles. The synthesized samples' thermal expansion coefficient was measured using thermal expansion equipment (Mettler Toledo, TMA/SDTA-LF/1100, Greifensee, Switzerland). The samples used for this experiment were cut to 4 mm×4 mm×4 mm. The thermal conductivity of the sample was measured using the thermal conductivity measurement equipment (c-TERM TCi, Fredericton, NB, Canada)) which uses a one-sided interfacial heat reflectance sensor.

### Example 5: Calculated Properties of the Composites

The benefit of making a cutting tool from a functionally graded (FG) composite is to enhance its thermal diffusivity, fracture toughness, and tribological characteristics. The addition of highly conductive inclusions within the core layers of FG composite is expected to improve its effective thermal conductivity and heat dissipation abilities during high-speed cutting operations. The fracture toughness of the FG composite will increase if the degree of thermal mismatch leads to the development of compressive residual stresses within the FG composite layers. On the other hand, the tribological properties can be improved by introducing solid lubricants (such as h-BN or MoS₂) to the outermost layers. Therefore, the present section primarily deals with selecting proper reinforcement materials to enhance effective thermal conductivity, thermal expansion mismatch, fracture toughness, and tribological characteristics in an FG Yb₂O₃-doped SiAlON ceramic composite.

The effective composite properties were calculated using the mean field and computational homogenization schemes for various ranges of reinforcement volume fractions, particle sizes, reinforcement material types, and composite layer thicknesses. Initially, the computational study was conducted for various reinforcement particle types, i.e., Ni, SiC, Co, TiCN, c-BN, h-BN, and MoS₂ [H. S. Syed, A. A. Abubakar, A. S. Hakeem, A Material-by-Design Approach to Develop Ceramic- and Metallic-Particle-Reinforced Ca-&alpha;-SiAlON Composites for Improved Thermal and Structural Properties, Nanomaterials, 2022, 12, which is incorporated herein by reference in its entirety]. The current examples showed that Co is preferable over Ni particles due to their lower melting temperatures. Furthermore, among the ceramic class, TiCN possesses better attribute. The introduction of Co and TiCN shows improvement in the effective properties and excellent chemical compatibility with the Yb₂O₃-doped SiAlON matrix; hence, also suitable reinforcers for the current examples. The h-BN is preferred over MoS₂ as the solid lubricant because it is widely used as a high-temperature solid lubricant in the ceramic matrix. MoS₂ is suitable for low to medium temperature applications and hence should not be used as a standalone solid lubricant for cutting applications [S. S. Akhtar, A critical review on self-lubricating ceramic-composite cutting tools, Ceram Int., 2021, 1-24, which is incorporated herein by reference in its entirety]. To investigate on suitability of using larger particle sizes and alloyed powder, Co212 reinforcement particles are included in the study. The Co, Co212, and TiCN particles are spherical, while the h-BN particles have a platelet shape with an aspect ratio of 28.6. For simplicity, the FG samples containing TiCN, Co, and Co212 are named A3, A4, and A5, respectively. The matrix material is Yb₂O₃-doped SiAlON, and the present section deals with further discussions about the computational study.

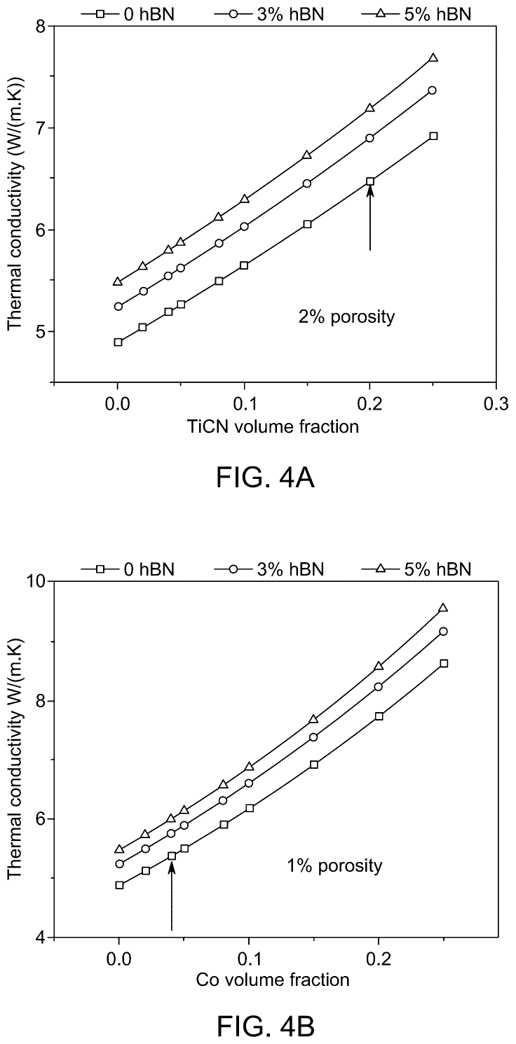

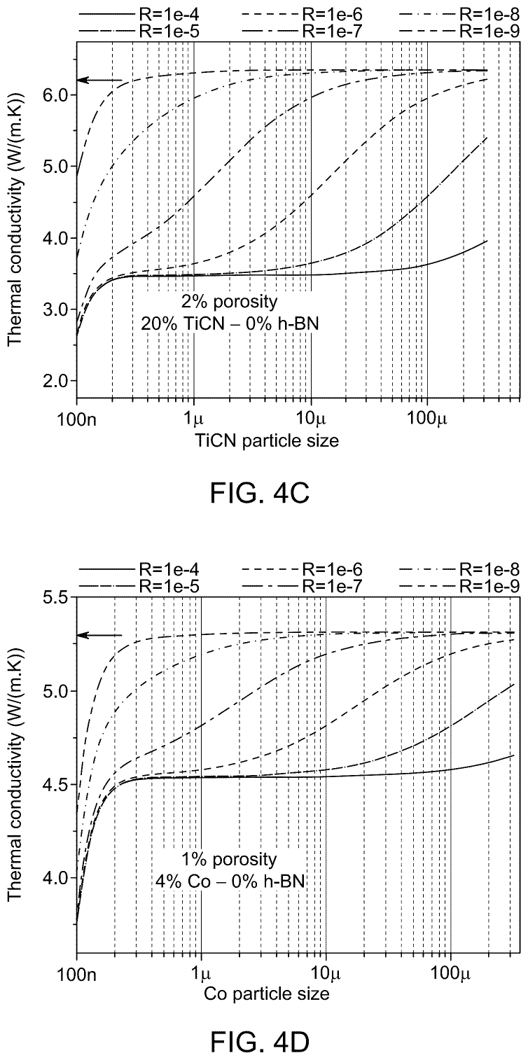

The effective properties of the FG composite are calculated using the material properties of MatWeb, (2022), Wang et al., and Syed et al. [H. Wang, Y. Xu, M. Shimono, Y. Tanaka, M. Yamazaki, Computation of interfacial thermal resistance by phonon diffuse mismatch model, Mater Trans., 2007, 48, 2349-2352; and H. S. Syed, A. A. Abubakar, A. S. Hakeem, A Material-by-Design Approach to Develop Ceramic- and Metallic-Particle-Reinforced Ca-&alpha;-SiAlON Composites for Improved Thermal and Structural Properties, Nanomaterials., 2022, 12, each of which is incorporated herein by reference in their entireties]. Effective thermal conductivity is examined for multiple ranges of interfacial thermal resistances. The effective thermal conductivity code is used to optimize the particle size and porosity fraction for the Yb₂O₃-doped SiAlON composite. Referring to FIG. 4A and FIG. 4B, the effective thermal conductivity variation with increasing volume fractions of TiCN and Co, along with the addition of the self-lubricating phase (i.e., h-BN particles) is shown. The thermal conductivity calculations are done for average particle sizes of 1.45 μm, 2 μm, and 32 μm for TiCN, Co, and Co212, respectively. The h-BN has 2D particle shapes: 70 nm×2 μm. The effective thermal conductivities are optimized using the interfacial resistance (ITR) values at the matrix-reinforcement interfaces are 1.0×10⁻⁹ K·m²/W. Since all the reinforcement particles have higher thermal conductivities than the pure Yb₂O₃-doped SiAlON matrix (i.e., 69.21 W/mK for Co/Co212, 30 W/mK for TiCN, and 6.67 W/mK for Yb₂O₃-doped SiAlON matrix), the effective thermal conductivity increases with increasing volume fractions of TiCN, Co, and h-BN. Co and h-BN result in higher thermal conductivity values than when TiCN and h-BN are added because Co has higher thermal conductivity than TiCN. Referring to FIG. 4C and FIG. 4D, in addition, higher thermal conductivities are calculated for the larger particle sizes in which the large interfacial resistance encountered for ultra-smaller particle sizes leads to poor effective thermal conductivity values. However, since low thermal interface resistance is typically reported for ceramics, the current study confirms that the differences between the effective thermal conductivities of Co212 and Co bulk ceramic composites is small; thus, no need for further evaluation of Co212 thermal properties. Furthermore, the ITR value for the h-BN/matrix interface is even smaller because of the functionalization procedure carried out before composite synthesis, as mentioned earlier. The Kaptza radius for the Yb₂O₃-doped SiAlON composite is about 0.6 μm and 0.4 μm for the TiCN, and Co interfaces (see, FIG. 4C and FIG. 4D), respectively; thus, the thermal boundary resistance created by the adopted particle sizes is insufficient to affect heat transport across the mating boundaries.

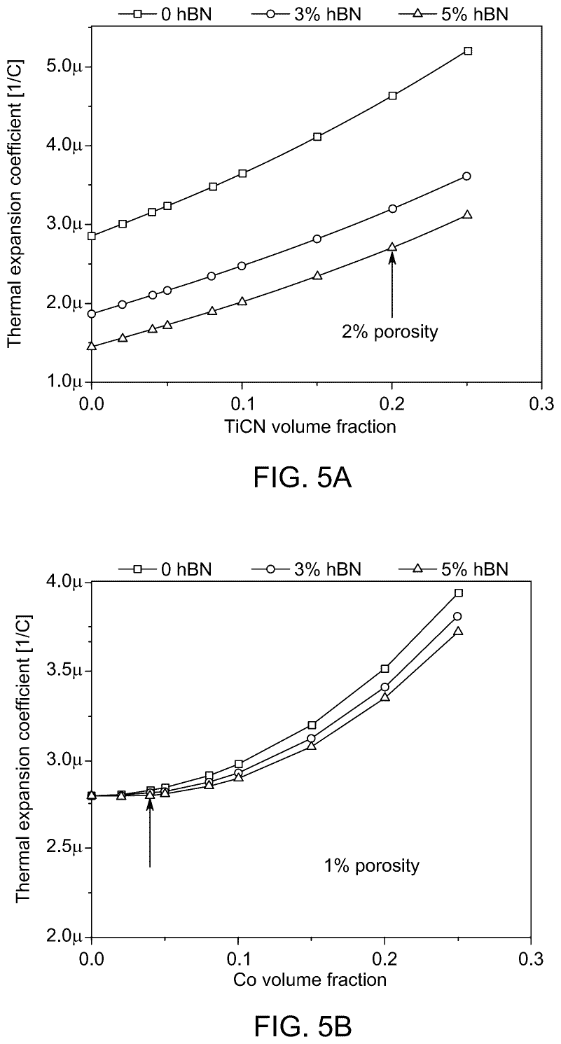

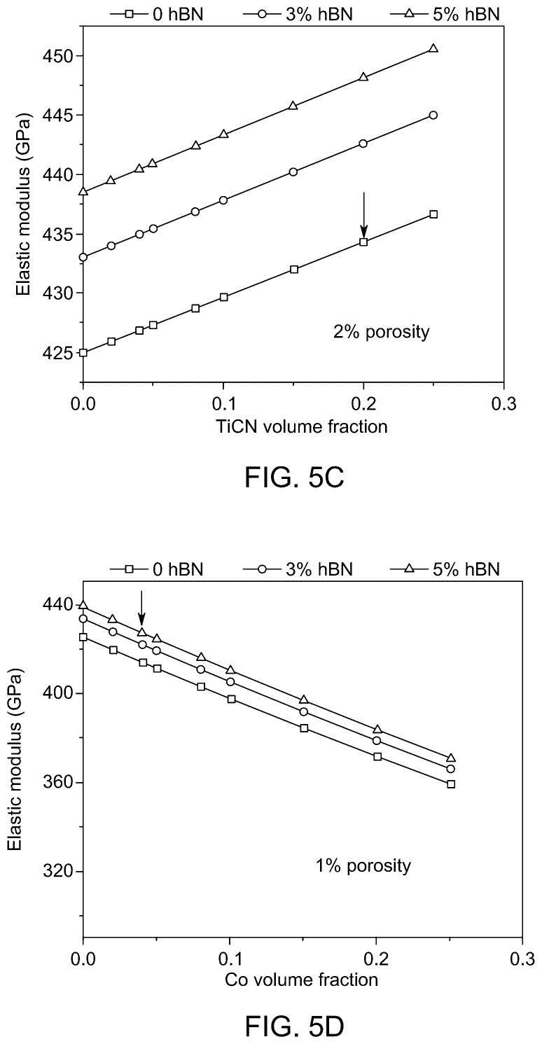

The structural properties of the composite are also affected by the reinforcement materials' volume fractions. Referring to FIG. 5, the effective coefficient of thermal expansion (CTE) and elastic modulus for Co/TiCN/Yb₂O₃-doped SiAlON composites for the same volume fraction ranges considered in the thermal conductivity calculations are shown. The effective CTE is calculated using the Mori-Tanaka theory, which was originally derived from Eshelby's theorem in elastic media. The effective CTE increases with increasing volume fractions of TiCN and reduces as the h-BN volume fractions increase (See, FIG. 5A). This indicates that the topmost composite layers containing higher volume fractions of h-BN will have lower CTE as desired. Moreover, it can be observed that adding Co provides the sharpest rise in the effective CTE with the nonlinear fashion as compared to when TiCN is added (See, FIG. 5A); nevertheless, adding h-BN does not result in any significant difference in values. For the same volume fractions, the large Co212 particles are expected to result in similar improvements in CTE values since the Mori-Tanaka scheme does not incorporate particle sizes. Since the development of compressive residual stresses is desired, the layered composite structure must maintain a low CTE towards the outer layers (containing 3-5% h-BN) and a high CTE in the core region (including 0% h-BN) as calculated here (See, FIGS. 5A and 5B). In addition, the effective elastic modulus of the composite should also be sufficient to result in compressive (thermal) residual stresses during high-speed cutting operations. The elastic modulus and hardness of TiCN are higher than that of Co (See, FIGS. 5C and 5D). Consequently, the effective elastic modulus of the composite reduces with the addition of Co and increases with increasing TiCN volume fractions. The added h-BN is considered a monolayer and, as such, has a high elastic modulus of 829 GPa; as such, adding h-BN increases the effective elastic modulus of the composite. The high elastic modulus of the h-BN becomes beneficial for developing compressive residual stresses since it is only added to the outer layers. At high cutting speeds, compressive residual stresses increase the fracture toughness of the cutting tool material.

The required volume fractions of reinforcement materials in the respective composite layers are chosen to utilize the calculations of the computational study and experimental observations. The FG composite structure contains five layers, and symmetry leads to three independent layers, as previously demonstrated in FIG. 2. The current experiments confirm and show that the high volume content of Co reinforcement particles resulted in the significant draining out of liquid Co out of the die during the spark plasma sintering operation, the Co volume fraction is limited to only 4% for the present study. Furthermore, the computational calculation of effective properties with the mean-field homogenization theories is not accurate for the non-dilute concentrations (i.e., volume fractions more than 25-30%). For this reason, the TiCN volume fraction is chosen not to exceed 20%. The h-BN is only required in the outer layers and solely for solid-lubrication purposes; thus, the maximum volume fraction of hBN is also pegged at 5%. The top layer of the FG structure contains: 20% TiCN or 4% Co/Co212 and 5% h-BN, the second layer contains 20% TiCN or 4% Co/Co212 and 3% h-BN, while the core layer has 20% TiCN or 4% Co/Co212 and 0% h-BN. Table 1 shows the calculated properties for the individual composite layers. For all the cases considered, the effective elastic modulus increases from the core to the outer layers due to the addition of h-BN. The thermal conductivity and CTE increase from the core to the outer layers for A3 and reduces for A4/A5. Since the computational codes cannot produce an effective value of properties for the bulk FG structure, computational homogenization simulations in COMSOL Multiphysics become necessary. The geometry of the layered composite structure was drawn based on the powder lamination thicknesses shown in FIG. 3. Then, the effective thermo-mechanical properties of the individual composite layer (shown in Table 1 for A3) were assigned to the COMSOL model. The effective thermo-mechanical properties of the bulk FG structure were calculated via integration, as shown in Table 1.

TABLE 1
The results of the computational runs for the three distinct layers
of the FG Yb₂O₃-doped SiAlON composites. A3 contains TiCN/hBN,
A4 contains Co/hBN, and A5 contains 32 μm Co alloy 212/hBN.

| Calculated Property | Layer | A3 | A4 & A5 |
|---|---|---|---|
| Elastic Modulus, E (GPa) | Top | 447.50 | 430.70 |
| | Second | 441.50 | 420.50 |
| | Core | 432.50 | 417.40 |
| | Bulk | 438.00 | 420.62 |
| Thermal Conductivity, k (W/mK) | Top | 5.88 | 6.01 |
| | Second | 6.03 | 5.49 |
| | Core | 6.48 | 5.01 |
| | Bulk | 6.23 | 5.34 |
| Coefficient of thermal | Top | 2.51 | 2.71 |
| expansion, α(μ/° C.) | Second | 3.20 | 2.72 |
| | Core | 4.55 | 2.75 |
| | Bulk | 3.76 | 2.74 |
| In-plane residual stress, σᵣ (MPa) | Top | −1019.20 | −18.58 |
| | Second | −435.25 | −9.50 |
| | Core | 518.87 | 14.01 |
| | Bulk | 6.00 | 0.19 |
| Elastic strain energy density, Γ(kJ/m³) | Top | 2020 | 0.59 |
| | Second | 3900 | 0.18 |
| | Core | 730 | 0.30 |
| | Bulk | 840 | 0.34 |

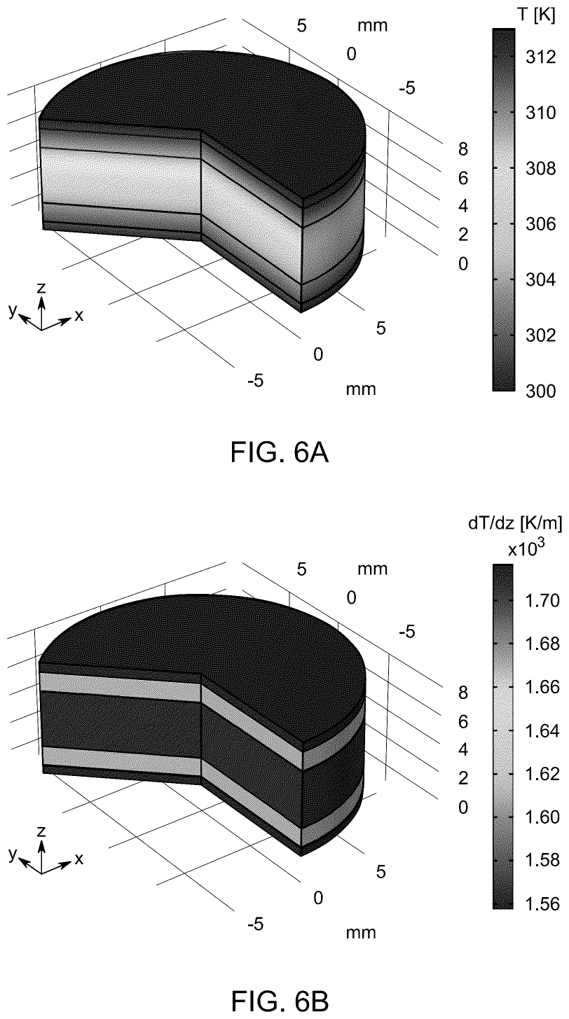

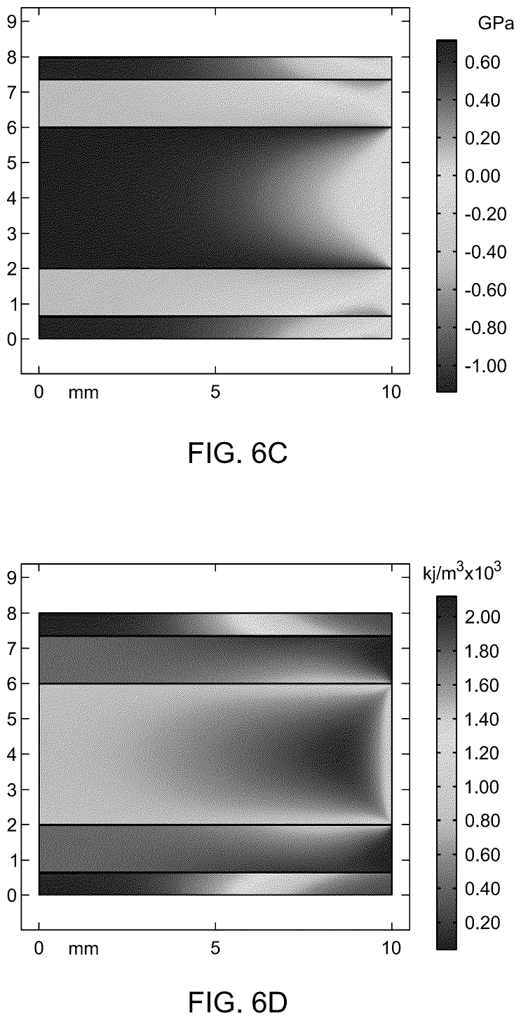

Referring to FIG. 6A, the temperature distribution across the thickness of the FG layered structure in which a temperature difference of 13K is imposed between the top and bottom surfaces is shown. The temperature gradient developed across the thickness direction is demonstrated in FIG. 6B. After integration across sample dimensions, A3 has the highest effective thermal conductivity and the effective coefficient of thermal expansion (CTE), followed by A4/A5. Also, A3 has a higher effective elastic modulus than A4/A5. The large variation in CTE values for samples A3 leads to the development of compressive residual stresses in the outer layers, as shown in FIG. 6C. Compressive residual stresses are beneficial for the tool life due to their desirable influence on cracks formation and growth. Consequently, the strain energy density related to fracture toughness remains higher in the layers of the FG composite structure (See, FIG. 6D) (see Table 2).

TABLE 2
Effective material properties used as
input into the COMSOL code for A3.

| Input property | Core | Second | Top |
|---|---|---|---|
| Density, ρ (kg/m³) | 3700 | 3440 | 3305 |
| Heat capacity at constant pressure, | 849 | 867 | 876.2 |
| Cₚ (J/(kg · K)) | | | |
| Poisson's ratio, ν | 0.25 | 0.25 | 0.25 |
| Thermal conductivity, k (W/m · K) | 6.48 | 6.03 | 5.88 |
| Young's modulus, E (GPa) | 432.50 | 441.50 | 447.50 |
| Coefficient of thermal expansion, α (μ/K) | 4.55 | 3.20 | 2.51 |

### Example 6: Microstructure and Characterization of the Synthesized Samples

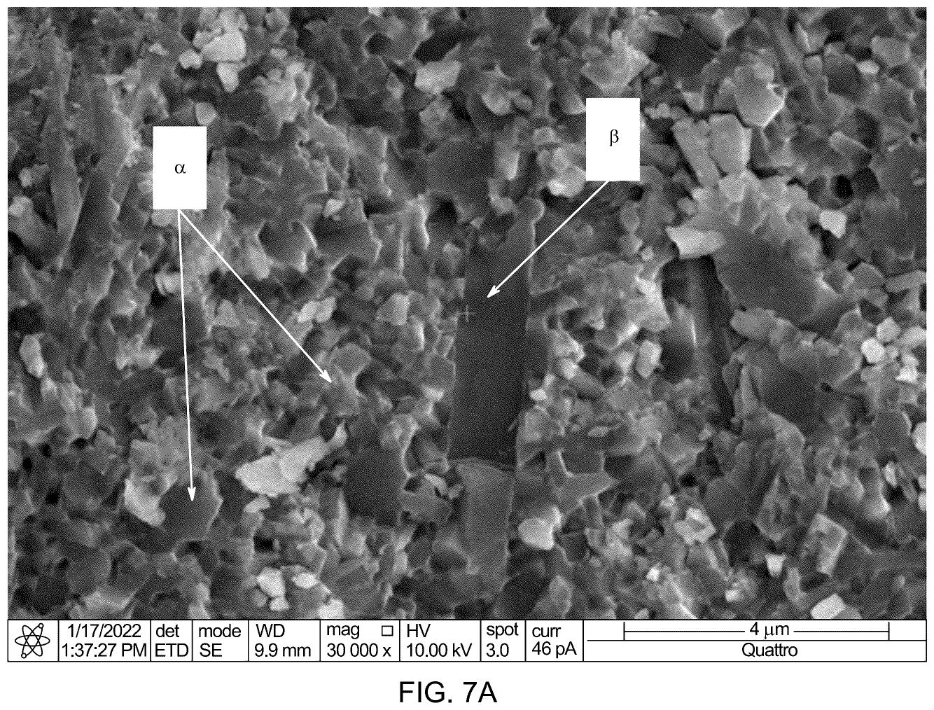

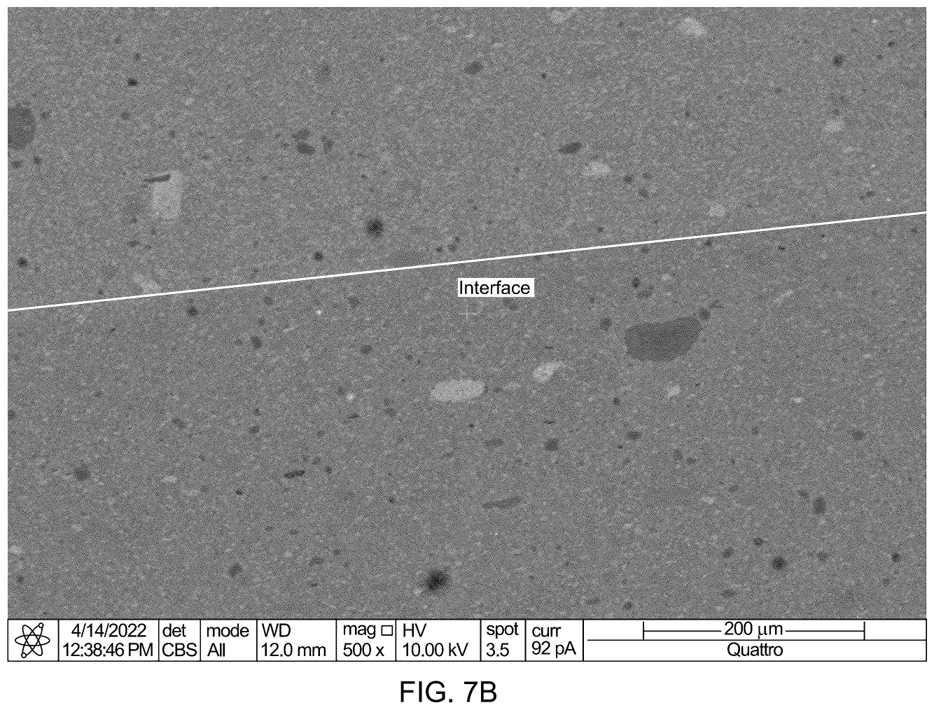

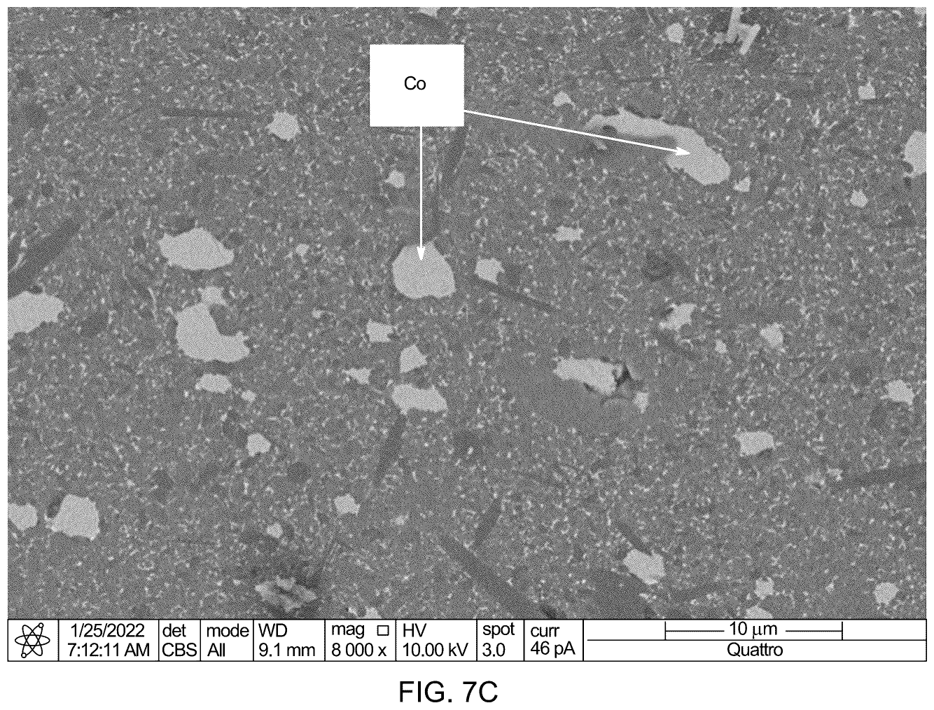

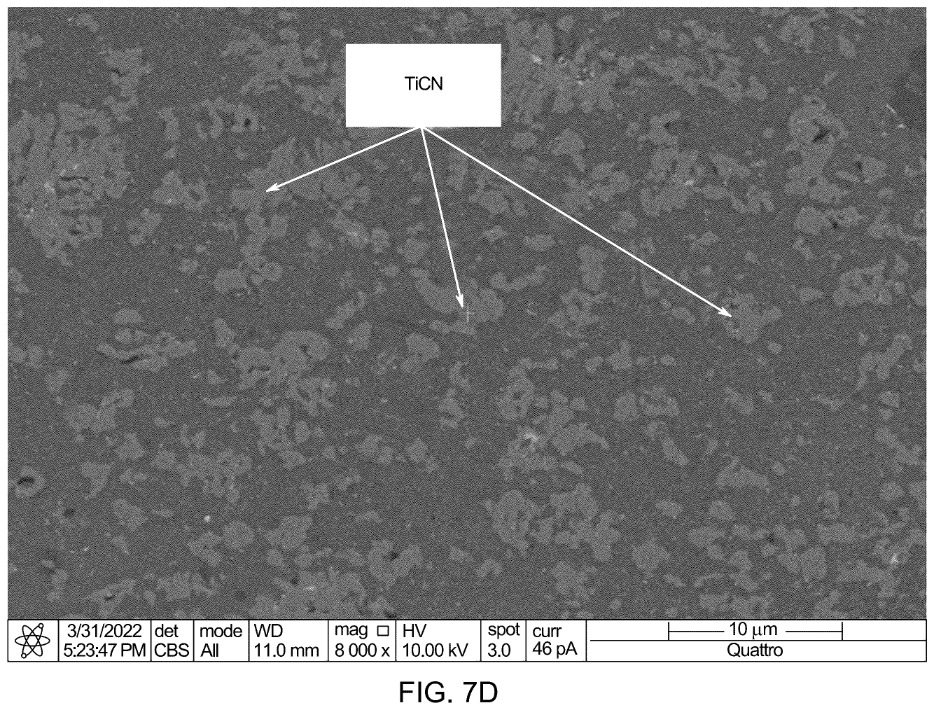

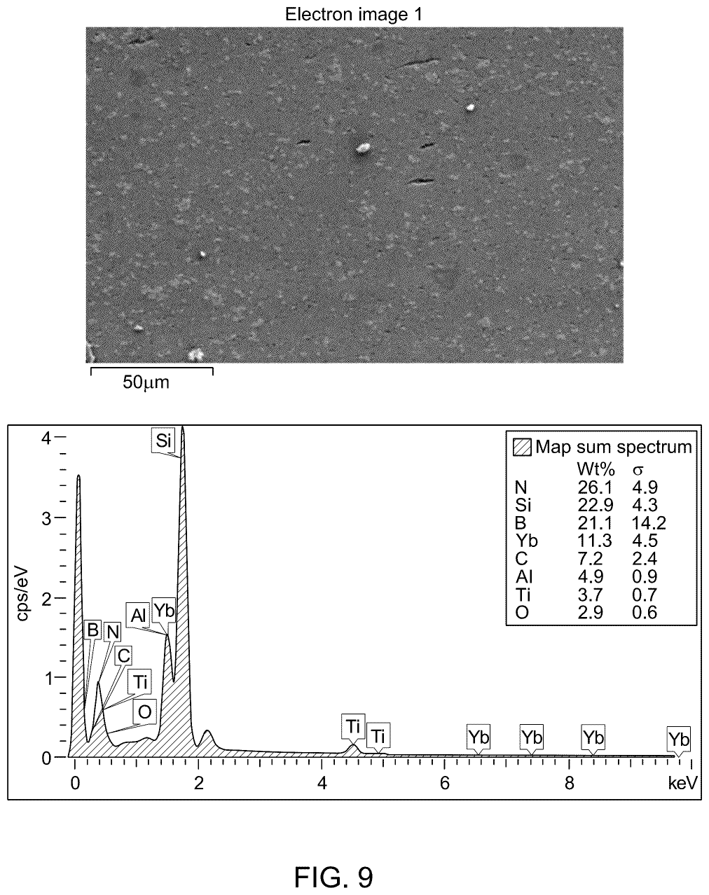

The present study relates to the FG composite structures. The discussions in this section are primarily made for samples A3, A4, and A5. Table 3 shows the composition of the individual layers in the A3, A4, and A5 samples. Each sample contains five symmetrical layers, three of which are independent. The matrix material is kept the same in all of the synthesized samples, i.e., Yb₂O₃-doped SiAlON. Minor β-phases were formed in the α-SiAlON matrix, as indicated in FIG. 7A, which shows the morphology of the fractured surface of the pure Yb₂O₃-doped SiAlON sample. FIG. 7B distinguishes the morphological differences between the top and second layers (for sample A3), which is a strong testament to the success of layering the multiple powder layers during the SPS synthesis. A closer view of the interface between the top and second layers, as demonstrated by the SEM image in FIG. 7B, shows adequate bonding of the respective layers. It is showed from the figures that the hBN particles have been fully dispersed in the matrix which is due to the functionalization of these particles. No major agglomeration or synthesis-induced issues were observed on the A3, indicating uniform dispersion of reinforcement particles (i.e., Co, h-BN, and TiCN) and explaining the strong mechanical bonding between the matrix and reinforcements. This work designed and synthesized particular compositions in the SPS with regards to enhancing the properties of cutting tool materials. Referring to FIG. 8, the XRD spectrum of the synthesized samples is shown. All the micro-constituents are detected, as shown in the figure. The β-SiAlON phase is also seen in the SiAlON matrix as previously demonstrated in FIG. 7A. The formation of the β-SiAlON phase in minor concentration is because of the M and N values used to synthesize the Yb₂O₃-doped SiAlON matrix. The M and N values were on the edge of the α-SiAlON phase region in the SiAlON phase diagram reported in the previous works [A. S. Hakeem, M. Khan, B. A. Ahmed, A. Al Ghanim, F. Patel, M. A. Ehsan, S. Ali, T. Laoui, S. Ali, Synthesis and characterization of alkaline earth and rare earth doped sialon Ceramics by spark plasma sintering, Int J Refract Metals Hard Mater. 2021, 97, 105500, which is incorporated herein by reference in its entirety]. These values are chosen to allow the use of all SiAlON precursors, which have contributed to the 99% high relative density and desirable thermo-mechanical properties attained. Therefore, having ytterbium oxide will result in optimal hardness and fracture toughness [M. Z. Falak, B. A. Ahmed, H. A. Saeed, S. U. Butt, A. S. Hakeem, U. A. Akbar, Spark plasma sintering of SiAlON ceramics synthesized via various cations charge stabilizers and their effect on thermal and mechanical characteristics, Crystals (Basel)., 2021, 11, 1378, which is incorporated herein by reference in its entirety]. The increase in the fracture toughness was attributed to the formation of discrete β-phases in the α-SiAlON matrix. Moreover, the compressive residual stresses, crack deflection, and bridging could also have contributed to the high fracture toughness observed in the composite structure. The Co peaks had low counts due to their lower volume fractions of 4 vol %. The phase analysis shows the presence of the Co phase in A2, A4, A5, and A7, along with having α-β SiAlON phases that are identical to that found in the pure sample. TiCN phase was also present in A3 and A6. The phase analysis was taken from the outer layers to capture the content of hBN. Compared to the referenced hBN powder, all major peaks of hBN have been identified in the FG samples of A3, A4, and A5. The presence of hBN also relates to the fracture toughness on the outer layers is lower than that in the pure SiAlON sample. The compositions employed in the composites were evident in the EDX spectra taken from the surface of sample A3 marked as A31 in FIG. 9.

TABLE 3
The composition by mass of all of the constituents of the FG
Yb₂O₃-doped SiAlON composite samples: A3, A4 and A5. In the layer
names, the first number represent the sample type and the second
represent the layer number: 1 and 5 are top layers, 2 and 4 are
second layers and 3 is the core layer, and 2 and 4 are the second layers.

| A3 TiCN | Yb₂O₃ | Si₃N₄ | AlN | SiO₂ | Al₂O₃ | TiCN | hBN | Total |
|---|---|---|---|---|---|---|---|---|
| A31 | 0.0846 | 0.4571 | 0.0833 | 0.0022 | 0.0025 | 0.0658 | 0.0216 | 0.7171 |
| A32 | 0.1685 | 0.9106 | 0.1659 | 0.0044 | 0.0050 | 0.2714 | 0.0267 | 1.5527 |
| A33 | 0.4590 | 2.4811 | 0.4521 | 0.0121 | 0.0137 | 1.6085 | 0 | 5.0265 |
| A34 | 0.1685 | 0.9106 | 0.1659 | 0.0044 | 0.0050 | 0.2714 | 0.0267 | 1.5527 |
| A35 | 0.0846 | 0.4571 | 0.0833 | 0.0022 | 0.0025 | 0.0658 | 0.0216 | 0.7171 |
| Total | 7.1864 | | | | | 2.2831 | 0.0967 | 9.5662 |
| A4 Co | Yb₂O₃ | Si₃N₄ | AlN | SiO₂ | Al₂O₃ | Co | hBN | Total |
| A41 | 0.0883 | 0.4774 | 0.0870 | 0.0023 | 0.0026 | 0.0183 | 0.0216 | 0.6976 |
| A42 | 0.1840 | 0.9944 | 0.1812 | 0.0049 | 0.0055 | 0.0755 | 0.0267 | 1.4721 |
| A43 | 0.5508 | 2.9773 | 0.5425 | 0.0145 | 0.0165 | 0.4474 | 0 | 4.5490 |
| A44 | 0.1840 | 0.9944 | 0.1812 | 0.0049 | 0.0055 | 0.0755 | 0.0267 | 1.4721 |
| A45 | 0.0883 | 0.4774 | 0.0870 | 0.0023 | 0.0026 | 0.0183 | 0.0216 | 0.6976 |
| Total | 8.1567 | | | | | 0.6350 | 0.0967 | 8.8884 |
| A5 Co212 | Yb₂O₃ | Si₃N₄ | AlN | SiO₂ | Al₂O₃ | Co212 | hBN | Total |
| A51 | 0.0883 | 0.4774 | 0.0870 | 0.0023 | 0.0026 | 0.0173 | 0.0216 | 0.6965 |
| A52 | 0.1840 | 0.9944 | 0.1812 | 0.0049 | 0.0055 | 0.0713 | 0.0267 | 1.4679 |
| A53 | 0.5508 | 2.9773 | 0.5425 | 0.0145 | 0.0165 | 0.4222 | 0.0000 | 4.5239 |
| A54 | 0.1840 | 0.9944 | 0.1812 | 0.0049 | 0.0055 | 0.0713 | 0.0267 | 1.4679 |
| A55 | 0.0883 | 0.4774 | 0.0870 | 0.0023 | 0.0026 | 0.0173 | 0.0216 | 0.6965 |

| | | | | |
|---|---|---|---|---|
| Total | 8.1567 | 0.5993 | 0.0967 | 8.8527 |

### Example 7: Physical and Thermo-Mechanical Properties

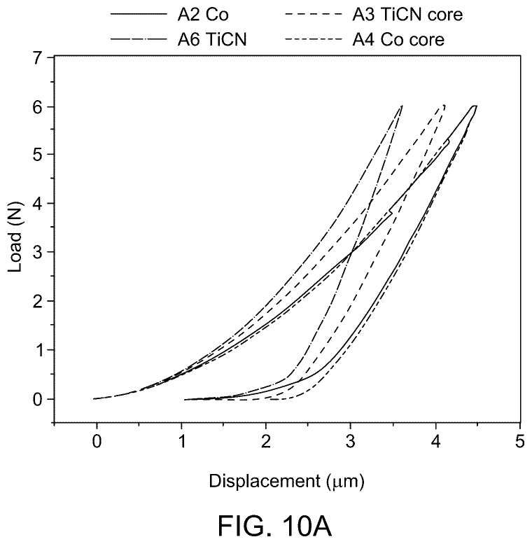

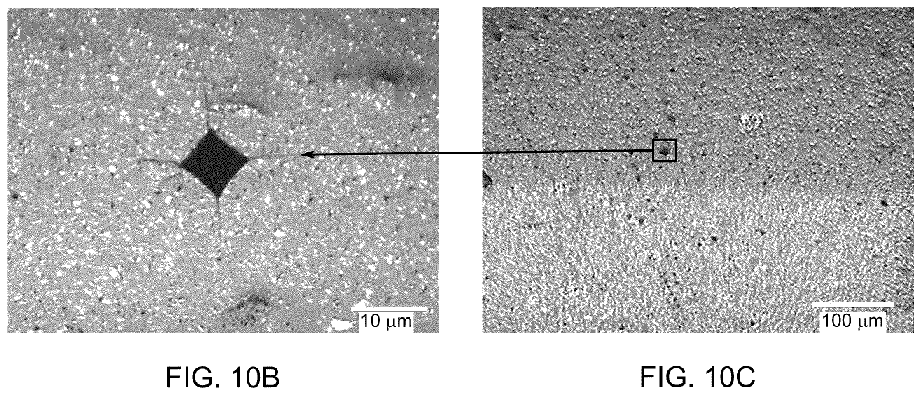

Density measurements were done using the Archimedes' principle highlighted in Table 4. An analysis provided in the present examples is that the pure SiAlON and Co-containing samples showed excellent actual densities ranging from 98 to 99% of the theoretical density. The TiCN containing samples have also demonstrated an improved density measurement of 98%, which considering the low synthesis temperatures, is a result that has ramifications on the structural and thermal properties. Physical measurements of the synthesized samples were done to confirm they match the volumes and dimensions that were considered in the design (Table 5). The mass loss during synthesis is found to be minimal. Some material loss is incurred during the sample preparation stages (such as powder mixing and sonication). The mass loss is observed for all composite layers, as previously indicated by microstructure investigations. Sample A5 shows the most prominent mass loss of 0.758 grams, leading to a total thickness loss of around 1 mm. This happens because some minor amount of Co melted outside of the die during the synthesis of sample A5; hence, this contributes to the total mass loss observed in A5. The micro indentation loading and unloading curves for the bulk samples and the core layers of the FG composites are shown in FIG. 10A. To investigate the existence of the compressive residual stresses in the FG composite samples, which is needed by design, the loading-unloading curves of the core layers (in A3, A4, and A5) were compared to that of the bulk samples (A2, A6, and A7). The experiments showed that the curves are not identical for all the cases, but instead, an offset is observed for all the cases. The offset is significantly larger for the TiCN containing FG sample (i.e., A3 when compared with A6). This is caused by the large tensile residual stresses developed in the core layer of A3 (i.e., about 600 MPa from FIG. 6C). The large compressive residual stresses developed in the top and second layers of A3 (FIG. 6C) lead to these high tensile residual stresses in the core layer, which shows that the design objectives have been strictly met. The indentation curves can be used to estimate the residual stresses developed in the core layer of A3. This is achieved by comparing the indentation curves of the stress-free (i.e., A6) and stressed (i.e., A3) samples. Since SiAlON ceramic possesses brittle (or sink-in) behavior, increasing the tensile residual stresses leads to increased penetration depth, as indicated by FIG. 10A. The residual stress developed in the core layer is calculated to be tensile with a magnitude of about ˜1.27 GPa using the recent model by Wang et al. [Q. Wang, K. Ozaki, H. Ishikawa, S. Nakano, H. Ogiso, Indentation method to measure the residual stress induced by ion implantation, Nucl Instrum Methods Phys Res B., 2006, 242 88-92, which is incorporated herein by reference in its entirety], i.e.,

$${σ}_{R} = \frac{{h}_{c}^{2}}{2 {h}_{f}^{2}} \cdot ( \frac{{L}_{0} - {L}_{s}}{{A}_{s}} )$$

(here: h_{f}˜4 μm is final indentation depth, h_{c}˜2.3 μm is contact depth, Aₛ=24.56 h_{c}² is projected contact area, Lₛ−L₀˜1 N is the load difference between stressed and stress-free samples), which is far greater than the one calculated from FIG. 6C. The significant difference between the numerical and experimental residual stress is due to either or all of the following: i) the adoption of only interlayer thermal mismatch strain, ii) the negligence of reinforcement particles characteristics and local stress concentration created by their presence within the ceramic matrix, and iii) the negligence of residual stresses induced by sources other than a thermal mismatch between layers in the numerical calculations. The formation of compressive residual stresses in the FG structure is beneficial for the cutting tool life because it can inhibit crack initiation and growth during high-speed machining operations. While the outer surface of the FG insert is subjected to compressive residual stress, tensile residual stresses must be present in the core layer. This contributes to the lower fracture toughness of the core layer compared to the bulk, as shown in Table 6. The hardness measurements were also taken from the synthesized samples' polished top surface. Optical images were taken from the indented locations to measure the crack lengths required for estimating adequate fracture toughness using the Evan's criteria. Referring to FIG. 10B the indented area in the A2 sample containing only Co particles is shown. FIG. 10C shows the indented locations at the top layer of A4 containing TiCN, in which the interface is visible in the image.

TABLE 4
Relative density of the synthesized samples. The density
measurements showed repeatability to within ±0.01%.

| Sample | A1 | A2 | A3 | A4 | A5 | A6 | A7 |
|---|---|---|---|---|---|---|---|
| Type | Pure | 4 vol % | FG | FG | FG | 20 vol % | 4 vol % |
| | | Co | TiCN | Co | Co212 | TiCN | Co212 |
| Density (g/cm³) | 3.46 | 3.70 | 3.725 | 3.575 | 3.566 | 3.89 | 3.633 |
| Theoretical | 3.49 | 3.72 | 3.795 | 3.610 | 3.596 | 4.08 | 3.691 |
| Density (g/cm³) | | | | | | | |
| Relative | 99% | 99% | 98.2% | 99% | 99% | 98.4% | 98.4% |
| Density (%) | | | | | | | |

TABLE 5
Physical measurements of the synthesized sample dimensions and weights.

| | | | | | | | | Mixed | |
|---|---|---|---|---|---|---|---|---|---|
| # | D1 | D2 | T1 | T2 | Diameter | Thickness | Weight | weight | variance |
| A3 | 20.4 | 20.4 | 7.56 | 7.54 | 20.46 | 7.55 | 8.993 | 9.566 | −0.573 |
| A4 | 20.1 | 20.2 | 7.36 | 7.36 | 20.2 | 7.36 | 8.334 | 8.888 | −0.554 |
| A5 | 20.5 | 20.54 | 6.96 | 7.06 | 20.56 | 7.01 | 8.095 | 8.853 | −0.758 |

TABLE 6
structural properties as obtained from the micro indentation
and the universal hardness measurements.

| | | Universal Hardness | | | | | | Modeling |
|---|---|---|---|---|---|---|---|---|
| | | fracture | | | Micro Indentation | | | Elasticity |
| Sample | Layer | toughness | Hardness | Std | Hardness | Std | Elasticity | calculated |
| A3 | Top | 4.4 | 2218 | 182 | — | | — | 397.12 |
| | Second | 5.5 | 2346 | 39.4 | 2587.4 | 37.4 | 303.2 | 411.28 |
| | Core | 6.5 | 2570 | 35.3 | 2684.8 | 54.6 | 269.4 | 434.4 |
| A4 | Top | 4.6 | 2291 | 47.14 | — | | — | 384.7 |
| | Second | 5.5 | 2374 | 73.9 | 2670.6 | 224.3 | 340 | 401.5 |
| | Core | 6.3 | 2388 | 94.9 | 2182.9 | 40 | 222.9 | 422.7 |
| A5 | Top | 5.3 | 2297 | 106 | — | | — | 384.7 |
| | Second | 4.8 | 2396 | 109 | 1740.2 | 166.7 | 173.5 | 401.5 |
| | Core | 5.2 | 2346 | 83.7 | 2565 | 271.6 | 329.9 | 422.7 |
| A1 | Bulk | 4.8 | 2110 | 36.5 | 3263.9 | 142.6 | 425.6 | NA |
| A2 | Bulk | 5.1 | 1847 | 11.5 | 2249.8 | 357.2 | 219.9 | 422.7 |
| A6 | Bulk | 7.5 | 2536 | 18.48 | 3040.4 | 84.4 | 436.4 | 434.4 |
| A7 | Bulk | 5 | 2336 | 98.32 | 2875.8 | 217.1 | 366.1 | 422.7 |

Table 6 shows that the calculated elastic modulus is identical to the one obtained experimentally for the bulk sample containing TiCN (A6). However, for the FG composite of A3, the results differ between the computations and the experiments due to the presence of residual stresses as mentioned earlier. The results were not consistent for the Co containing samples. This is because subsequent microstructure investigations by SEM revealed that the Co content has undergone agglomeration for all the FG and bulk samples. Micro indentation data also established the presence of a large standard deviation for the Co containing samples with 357.2 HV compared to 84.4 HV for the TiCN samples, which further indicates the influence of particle agglomeration on the effective composite properties. The bulk sample of A6 containing 20 vol % TiCN has shown an increase in the fracture toughens by 56% compared to the pure Yb₂O₃-doped SiAlON sample and has higher stiffness of 436.4 GPa compared to 425.6 GPa. On the other hand, the core layer of A3 which contains 20 vol % of TiCN have shown an increase in the fracture toughness by about 35%. The reason for the reduction in the toughness improvement for the core layer as compared to the bulk samples is the presence of tensile residual stresses as mentioned earlier. The pure SiAlON sample A1 shows a combination of high fracture toughness and hardness due to the formation of some minor amounts of the elongated β-phase surrounded by the equiaxed α-phase [A. S. Hakeem, M. Khan, B. A. Ahmed, A. Al Ghanim, F. Patel, M. A. Ehsan, S. Ali, T. Laoui, S. Ali, Synthesis and characterization of alkaline earth and rare earth doped sialon Ceramics by spark plasma sintering, Int J Refract Metals Hard Mater. 2021, 97, 105500, which is incorporated herein by reference in its entirety].

The thermal conductivity and coefficient of thermal expansion that were calculated by the computational homogenization and effective medium approximation were compared with the experimentally derived results, as shown in Table 7. The calculation of the TiCN sample has stayed consistent with what has been observed in the experiments; thus, the bulk sample, A6, shows a thermal conductivity and coefficient of thermal expansion approximately similar to the one measured experimentally. The same is for the FG sample of A3, in which the thermal expansion is calculated to be about 3.25 μ/° C. compared to the 3.37 μ/° C. measured experimentally. Nevertheless, the trend of calculation and measurements are similar, and the differences between the calculated and experimental thermal conductivity values are small. Therefore, the current investigation shows that FG TiCN/h-BN/SiAlON composite material can be used to attain the best cutting performance due to the significant improvement in the thermo-mechanical and tribological properties needed in tool insert materials. Furthermore, the development of compressive residual stresses becomes an added benefit for using functionally graded tool insert material. Other modifications are possible that can help to increase the accuracy of the models, explore the wettability of metals with SiAlON, and further investigate the agglomeration phenomena of Co particles. The thermal properties of the Co containing samples were not as calculated due to the agglomeration as mentioned earlier and the effect of a large thermal mismatch between the Co and the SiAlON matrix. Moreover, the melting and draining if Co out of the die considerably affects the thermal conductivity of the ceramic composite. Unlike TiCN, adding Co and other metals, such as nickel, requires great care and intensive optimization of volume fractions and SPS parameters. As investigated by the effective thermal expansion coefficient and micro indentation analysis, the FG TiCN+hBN+SiAlON composite of five layers has satisfied the design objective of inducing compressive residual stresses and enhancing the fracture toughness and that is a novel and unique design approach not available in the open literature.

TABLE 7
Comparing calculated effective thermal conductivity and thermal
expansion coefficient to the experimental measurements.

| | |
|---|---|
| Thermal Conductivity | Thermal Expansion |

| Sample | Measured | Calculated | Measured | Calculated |
|---|---|---|---|---|
| A1 | 4.909 | NA | 2.86 | NA |
| A2 | 4.352 | 5.01 | 2.78 | 3.36 |
| A3 | 4.96 | 6.23 | 3.37 | 3.25 |
| A4 | 4.59 | NA | 2.8 | NA |
| A5 | 4.2 | Na | 2.92 | NA |
| A6 | 6.08 | 6.21 | 4.19 | 4.32 |
| A7 | 4.86 | 5.01 | 2.72 | 3.36 |

The advantages of the tools and method of making in the present invention include providing a functionally graded (FG) SiAlON composite cutting tool with thermal superiority.

Furthermore, the composites of the present disclosure show higher improvement in thermo-mechanical properties. Also, the fracture toughness of the composites is substantially higher the bulk TiCN sample compared to the pure SiAlON sample. The composites and tools of the present disclosure include optimal and adaptable composite properties, such as, reinforcing volume fractions, particle sizes, layer numbers, layer material compositions, interfacial resistance, and porosity, and improved thermomechanical and tribological attributes that are industrially desirable and adaptable for multiple applications.

Numerous modifications and variations of the present disclosure are possible in light of the above teachings. It is therefore to be understood that within the scope of the appended claims, the invention may be practiced otherwise than as specifically described herein.

1: A functionally graded (FG) SiAlON composite cutting tool, comprising:
a cutting head having a cutting surface;
wherein the cutting surface comprises the FG SiAlON composite;
wherein the FG SiAlON composite is obtained by sintering one or more powder compositions, and wherein the one or more powder compositions comprise SiO₂ particles having a particle size of 20 to 50 nanometers (nm), AlN particles having a particle size of up to 100 nm, Si₃N₄ particles having a particle size of 300 to 500 nm, Al₂O₃ particles having a particle size of up to 100 nm, Yb₂O₃ particles having a particle size of up to 100 nm, and one or more reinforcement additives selected from the group consisting of cobalt (Co) particles, titanium carbonitride (TiCN) particles, cobalt alloy particles, and a boron nitride compound; and
wherein the one or more reinforcement additives of the one or more powder compositions have an average particle size in a range of 50 nm to 35 micrometers (μm).

2: The FG SiAlON composite cutting tool of claim 1, wherein the one or more reinforcement additives of the one or more powder compositions comprise the Co particles, the TiCN particles and the cobalt alloy particles, and wherein:
the Co particles has an average particle size of about 2 μm;
the TiCN particles has an average particle size of about 1.45 μm; and
the cobalt alloy particles has an average particle size of about 32 μm.

3: The FG SiAlON composite cutting tool of claim 1, wherein the one or more reinforcement additives of the one or more powder compositions comprise the cobalt alloy particles of a cobalt-chromium alloy (Co212-C), and wherein the Co212-C comprises about 0.5 to 1 wt. % Fe, about 0.1 to 0.6 wt. % C, about 27 to 30 wt. % Cr, about 1 wt. % or less Ni, about 5 to 7 wt. % Mo, about 1 wt. % or less Si, about 1 wt. % or less Mn, and a Co balance, each wt. % based on a total weight of the Co212-C.

4: The FG SiAlON composite cutting tool of claim 1, wherein the one or more reinforcement additives of the one or more powder compositions comprise at least one boron nitride compound selected from the group consisting of a hexagonal boron nitride (h-BN), a modified h-BN, a rhombohedral boron nitride, a modified rhombohedral boron nitride, a turbostratic boron nitride, and a modified turbostratic boron nitride.

5: The FG SiAlON composite cutting tool of claim 4, wherein the boron nitride compound is h-BN comprising platelet-shaped particles, and wherein the platelet-shaped particles have a thickness of 50 to 100 nm, a length of 1 to 5 μm, and an aspect ratio of 10 to 100.

6: The FG SiAlON composite cutting tool of claim 1, wherein the FG SiAlON composite of the cutting surface comprises 5 layers of 3 symmetrical compositions having a total thickness (T), and wherein the 5 layers of the FG SiAlON composite comprises:
a bottom layer above and adjacent to the cutting surface of the cutting head;
a first inner layer above and adjacent to the bottom layer;
a core layer above and adjacent to the first inner layer;
a second inner layer above and adjacent to the core layer; and
a top layer above and adjacent to the second inner layer;
wherein the bottom layer and the top layer have the same first composition and are obtained from a first powder composition and have a first thickness (t₁);
wherein the first inner layer and the second inner layer have the same second composition and are obtained from a second powder composition and have a second thickness (t₂);
wherein the core layer have a third composition and is obtained from a third powder composition and have a core thickness (t_{c}); and
wherein 2×t₁+2×t₂+t_{c}=T.

7: The FG SiAlON composite cutting tool of claim 6, wherein:
a first ratio of t₁ to T of the FG SiAlON composite is about 1:20 to 1:10;
a second ratio of t₂ to T of the FG SiAlON is about 1:10 to 1:5; and
a third ratio of t_{c} to T of the FG SiAlON is about 2:5 to 2:3.

8: The FG SiAlON composite cutting tool of claim 6, wherein:
t₁ is about 0.655 millimeters (mm);
t₂ is about 1.35 mm; and
t_{c} is about 4 mm.

9: The FG SiAlON composite cutting tool of claim 6, wherein the first composition of the bottom layer and the top layer of the FG SiAlON composite and the first powder composition are substantially the same, and wherein the first powder composition comprises:
0.25 to 0.4 wt. % SiO₂;
10 to 14 wt. % AlN;
60 to 70 wt. % Si₃N₄;
0.3 to 0.45 wt. % Al₂O₃;
10 to 14 wt. % Yb₂O₃;
2 to 4 wt. % h-BN;
optionally 8 to 10 wt. % TiCN;
optionally 2 to 3 wt. % Co; and
optionally 2 to 3 wt. % Co212-C, each wt. % based on a total weigh of the first powder composition.

10: The FG SiAlON composite cutting tool of claim 6, wherein the second composition of the first inner layer and the second inner layer of the FG SiAlON composite and the second powder composition are substantially the same, and wherein the second powder composition comprises:
0.25 to 0.4 wt. % SiO₂;
8 to 14 wt. % AlN;
55 to 70 wt. % Si₃N₄;
0.3 to 0.45 wt. % Al₂O₃;
8 to 14 wt. % Yb₂O₃;
1 to 3 wt. % h-BN;
optionally 15 to 20 wt. % TiCN;
optionally 4 to 6 wt. % Co; and
optionally 4 to 6 wt. % Co212-C, each wt. % based on a total weigh of the second powder composition.

11: The FG SiAlON composite cutting tool of claim 6, wherein the third composition of the core layer of the FG SiAlON composite and the third powder composition are substantially the same, and wherein the third powder composition comprises:
0.2 to 0.4 wt. % SiO₂;
6 to 15 wt. % AlN;
45 to 75 wt. % Si₃N₄;
0.2 to 0.45 wt. % Al₂O₃;
6 to 15 wt. % Yb₂O₃;
optionally 25 to 40 wt. % TiCN;
optionally 8 to 12 wt. % Co; and
optionally 8 to 12 wt. % Co212-C, each wt. % based on a total weigh of the third powder composition.

12: The FG SiAlON composite cutting tool of claim 6, wherein:
the bottom layer and the top layer of the FG SiAlON composite comprises about 0.31 wt. % SiO₂, about 11.62 wt. % AlN, about 63.74 wt. % Si₃N₄, about 0.35 wt. % Al₂O₃, about 11.80 wt. % Yb₂O₃, about 9.18 wt. % TiCN, about 3.01 wt. % h-BN, each wt. % based on a total weight of the first composition;
the first inner layer and the second inner layer of the FG SiAlON composite comprises about 0.28 wt. % SiO₂, about 10.68 wt. % AlN, about 58.65 wt. % Si₃N₄, about 0.32 wt. % Al₂O₃, about 10.85 wt. % Yb₂O₃, about 17.48 wt. % TiCN, about 1.72 wt. % h-BN, each wt. % based on a total weight of the second composition; and
the core layer of the FG SiAlON composite about 0.24 wt. % SiO₂, about 8.99 wt. % AlN, about 49.36 wt. % Si₃N₄, about 0.27 wt. % Al₂O₃, about 9.13 wt. % Yb₂O₃, about 32.00 wt. % TiCN, each wt. % based on a total weight of the third composition.

13: The FG SiAlON composite cutting tool of claim 12, wherein the FG SiAlON composite has:
a density of about 3.725 g/cm3;
a thermal conductivity of 4.8 to 6.3 W/mK; and
a thermal expansion coefficient of 3.1 to 3.5 μ/° C.

14: The FG SiAlON composite cutting tool of claim 6, wherein:
the bottom layer and the top layer of the FG SiAlON composite comprises about 0.33 wt. % SiO₂, about 12.47 wt. % AlN, about 68.43 wt. % Si₃N₄, about 0.37 wt. % Al₂O₃, about 12.66 wt. % Yb₂O₃, about 2.62 wt. % Co, about 3.10 wt. % h-BN, each wt. % based on a total weight of the first composition;
the first inner layer and the second inner layer of the FG SiAlON composite comprises about 0.33 wt. % SiO₂, about 12.31 wt. % AlN, about 67.55 wt. % Si₃N₄, about 0.36 wt. % Al₂O₃, about 12.50 wt. % Yb₂O₃, about 5.13 wt. % Co, about 1.81 wt. % h-BN, each wt. % based on a total weight of the second composition; and
the core layer of the FG SiAlON composite comprises about 0.32 wt. % SiO₂, about 11.93 wt. % AlN, about 65.45 wt. % Si₃N₄, about 0.36 wt. % Al₂O₃, about 12.11 wt. % Yb₂O₃, about 9.84 wt. % Co, each wt. % based on a total weight of the third composition.

15: The FG SiAlON composite cutting tool of claim 14, wherein the FG SiAlON composite has:
a density of about 3.575 g/cm3;
a thermal conductivity of 4.4 to 4.8 W/mK; and
a thermal expansion coefficient of 2.6 to 3.0 μ/° C.

16: The FG SiAlON composite cutting tool of claim 6, wherein:
the bottom layer and the top layer of the FG SiAlON composite comprises about 0.33 wt. % SiO₂, about 12.49 wt. % AlN, about 68.54 wt. % Si₃N₄, about 0.37 wt. % Al₂O₃, about 12.68 wt. % Yb₂O₃, about 2.48 wt. % Co212-C, about 3.10 wt. % h-BN, each wt. % based on a total weight of the first composition;
the first inner layer and the second inner layer of the FG SiAlON composite comprises about 0.33 wt. % SiO₂, about 12.34 wt. % AlN, about 67.74 wt. % Si₃N₄, about 0.37 wt. % Al₂O₃, about 12.53 wt. % Yb₂O₃, about 4.86 wt. % Co212-C, about 1.82 wt. % h-BN, each wt. % based on a total weight of the second composition; and
the core layer of the FG SiAlON composite comprises about 0.32 wt. % SiO₂, about 11.99 wt. % AlN, about 65.81 wt. % Si₃N₄, about 0.36 wt. % Al₂O₃, about 12.18 wt. % Yb₂O₃, about 9.33 wt. % Co212-C, each wt. % based on a total weight of the third composition.

17: The FG SiAlON composite cutting tool of claim 16, wherein the FG SiAlON composite has:
a density of about 3.566 g/cm3;
a thermal conductivity of 3.8 to 4.4 W/mK; and
a thermal expansion coefficient of 2.7 to 3.1 μ/° C.

18: A method of making the FG SiAlON composite cutting tool of claim 1, comprising:
mixing nanoparticles of SiO₂, AlN, Si₃N₄, Al₂O₃, and Yb₂O₃, and one or more reinforcement additives selected from the group consisting of cobalt (Co), titanium carbonitride (TiCN), a cobalt alloy, and a boron nitride compound in a solvent and sonicating to form a first mixture;
drying the first mixture to form a first powder composition;
mixing the nanoparticles of SiO₂, AlN, Si₃N₄, Al₂O₃, and Yb₂O₃, and the one or more reinforcement additives selected from the group consisting of cobalt (Co) particles, titanium carbonitride (TiCN) particles, cobalt alloy particles, and a boron nitride compound in the solvent and sonicating to form a second mixture;
drying the second mixture to form a second powder composition;
mixing the nanoparticles of SiO₂, AlN, Si₃N₄, Al₂O₃, and Yb₂O₃, and the one or more reinforcement additives selected from the group consisting of cobalt (Co) particles, titanium carbonitride (TiCN) particles, and cobalt alloy particles in the solvent and sonicating to form a third mixture;
drying the third mixture to form a third powder composition;
forming a sample by introducing a first portion of the first powder composition onto the cutting surface of the cutting head thereby forming a bottom powder layer disposed on the cutting surface, introducing a first portion of the second powder composition onto a surface of the bottom powder layer thereby forming a first inner powder layer, introducing the third powder composition onto a surface of the first inner powder layer thereby forming a core powder layer, introducing a second portion of the second powder composition onto a surface of the core powder layer thereby forming a second inner powder layer, and introducing a second portion of the first powder composition onto a surface of the second inner powder layer thereby forming a top powder layer; and
sintering by pressing and heating the sample via the top powder layer to form the FG SiAlON composite on the cutting surface of the cutting head;
wherein the FG SiAlON composite comprises 5 layers of 3 symmetrical compositions and have a total thickness (T);
wherein the FG SiAlON composite comprises a bottom layer above and adjacent to the cutting surface of the cutting head, a first inner layer above and adjacent to the bottom layer, a core layer above and adjacent to the first inner layer, a second inner layer above and adjacent to the core layer, and a top layer above and adjacent to the second inner layer;
wherein the bottom layer and the top layer have the same first thickness (t₁);
wherein the first inner layer and the second inner layer have the same second thickness (t₂);
wherein the core layer has a core thickness (t_{c});
wherein 2×t₁+2×t₂+t_{c}=T;
wherein a first ratio of t₁ to T is about 0.08;
wherein a second ratio of t₂ to T is about 0.17; and
wherein a third ratio of t_{c} to T is about 0.5.

19: The method of claim 18, wherein the solvent is at least one alcohol selected from the group consisting of methanol, ethanol and propanol.

20: The method of claim 18, wherein the pressing is performed under a uniaxial pressure in a range of 30 to 70 megaPascals (MPa), and wherein the heating is performed at a temperature in a range of 1400 to 1600° C.
